(19) United States
(12) Patent Application Publication
(10) Pub. No.: US 2004/0252982 A1
(43) Pub. Date: Dec. 16, 2004

(54) Recording apparatus, program, and integrated circuit

(76) Inventors: Yuji Iwahara, Higashihiroshima-shi (JP); Ryuichi Hori, Hirosima-shi (JP); Youichi Yamamoto, Hiroshima-ku (JP); Masako Ninomiya, Hiroshima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/864,326

(22) Filed: Jun. 10, 2004

(30) Foreign Application Priority Data
Jun. 11, 2003 (JP) 2003-167057

(51) Int. Cl. H04N 5/76; H04B 1/66

(52) U.S. Cl. 386/111; 386/112

(57) ABSTRACT

A recording apparatus, allowing a user to view video data while dubbing of other video data, which requires the actual time of the video data, is executed. The recording apparatus comprises a view buffer, and an encode buffer. A MPEG2 decoder decodes a VOBU for dubbing and a VOBU for viewing in parallel by time-sharing, writes the decoded VOBU for dubbing into the encode buffer, and writes the decoded VOBU for viewing into the view buffer. A MPEG2 encoder encodes the decoded VOBU for dubbing stored in the encode buffer. The MPEG2 decoder performs the decoding and the writing at a higher processing rate than a display rate for reproduction. A display control unit reads and reproduces, at the display rate, the decoded VOBU for viewing which is written into the view buffer at the higher processing rate.

### BACKGROUND OF THE INVENTION

(1) Field of the Invention

The present invention relates to a recoding apparatus, a program, and an integrated circuit for receiving broadcast content and writing the received content into a built-in medium, and more specifically relates to the art of copying the written content to a portable medium for showing the content to a user.

(2) Description of the Related Art

In recent years, a new attempt to realize a recording apparatus which supports mobile devices has been made. Generally, a recording apparatus encodes broadcast content into content in a compressed format using the MPEG2 standard, and writes the encoded content into a built-in HDD. Here, “a recording apparatus which supports mobile devices” means a recording apparatus which can write the content recorded in the HDD into a SD memory card, a DVD, or the like, after re-encoding the content.

Movie content can be highly compressed by re-encoding for lowering the bit rate of the content. This allows even a SD memory card, having only 256 MB storage capacity, and a DVD, having 4.7 GB storage capacity, to store a larger amount of movie content.

By re-encoding and copying content from the HD to a SD memory card or a DVD, a user can view the content with a portable player, a PDA, or a mobile phone as well as the recording apparatus itself. This means that the user can view the content anytime and anywhere. For instance, the user can view a news program on the way to work or during breaks. The user can get more convenience of the recording apparatus.

However, to re-encode content recorded in a HDD, a recording apparatus has to restore the content to a video signal and an audio signal. A decoder included in the recording apparatus exclusively restores the encoded content to a video signal and an audio signal, and the re-encoding takes actual-time, meaning that if the content is an hour long, the decoding of the content takes an hour as well. As a result, the recording apparatus cannot reproduce other content during the re-encoding because of the exclusive restoration by the decoder. If the content is an hour long, the user has to wait to view other content recorded in the HDD.

As a matter of course, the user can view the content which is being re-encoded, because the content is being decoded at the same time. However, it is far from the ideal style of the mobile-supporting recording apparatus for the user who wishes to view the content on the way to work or during breaks.

### SUMMARY OF THE INVENTION

The object of the present invention is therefore to provide a recording apparatus which allows a user to view video data while dubbing of other video data, which requires the actual time of the video data, is executed.

The above object is fulfilled by a recording apparatus which executes, in parallel, processes of (1) re-encoding first video data recorded in a first storage medium, and writing the re-encoded first video data into a second storage medium, and (2) reproducing second video data, comprising: a reading unit operable to read the first video data and the second video data from the first storage medium; a view buffer; an encode buffer; a decoder operable to decode the first video data and the second video data by time-sharing, write the decoded first video data into the encode buffer, and write the decoded second video data into the view buffer; an output unit operable to output the decoded second video data stored in the view buffer at a display rate; and an encoder operable to encode the decoded first video data stored in the encode buffer, wherein the decoder performs the decoding and the writing at a higher processing rate than the display rate. This allows the recording apparatus to perform the decoding of the first video data and the decoding of the second video data by time-sharing at the higher processing rate than the display rate for the reproduction. The recording apparatus stores the decoded second video data in the view buffer and reproduces the stored data. The decoded second video data, which is generated at the high processing rate, is to be reproduced at the normal display rate. As a result, the user can view the second video data recorded in the first storage medium while dubbing of the fist video data from the first storage medium to the second storage medium accompanied by re-encoding is executed.

Here, the recording apparatus may comprise a control unit operable to monitor an amount of the second video data accumulated in the view buffer and an amount of the first video data accumulated in the encode buffer, wherein the reading of the first video data is performed when the amount of the accumulation in the view buffer reaches a first threshold value, and the reading of the second video data is performed when the amount of the accumulation in the encode buffer reaches a second threshold value.

This allows the recording apparatus to provide the decoder with the video data before either of the view buffer or the encode buffer overflows. As a result, the decoding is seamlessly executed.

Here, the recording apparatus may output a composite picture consisting of the second video data as a main picture and the first video data as a sub-picture, the composite picture being generated by compositing the decoded first video data with the decoded second video data.

This allows the user to know the progress of the re-encoding of the first video data during the decoding of the second video data.

Here, the recording apparatus may be a recording apparatus wherein the encode buffer includes a re-encode buffer and a record buffer, the decoder decodes the first video data and writes the decoded first video data into the re-encode buffer, the recording apparatus further comprises a reception unit operable to receive a broadcast wave in order to obtain uncompressed digital data, and write the obtained data into the record buffer, and the encoder re-encodes the decoded data in the re-encode buffer and encodes the uncompressed digital data in the record buffer by time-sharing at the higher processing rate than the display rate.

This allows the user to record broadcast content which is broadcasted during the re-encoding, and the user does not miss the opportunity to record the content.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a configuration of a HD recorder 100;

FIG. 2 is an internal configuration of the HD recorder 100 according to the first embodiment;

FIG. 3 is an enlarged figure which represents a configuration of a MPEG2 decoder 7, a view buffer 8, a frame memory a, b, c, and a display control unit 10, which are abstracted from the internal configuration of the recording apparatus;

FIG. 4 is a functional block diagram which represents concrete means embodied by the cooperation among programs stored in a ROM of a microcomputer system 19 and hardware resources;

FIG. 5 is a timing diagram which shows the status transitions of the track buffer 6, the view buffer 8, and the encode buffer 11 in FIG. 2 and the timing of the switch between a reproduction control and a re-encoding control;

FIG. 6A is an example Content Navigation;

FIG. 6B is an example Content Navigation with specific recording date and hours, channels, and titles;

FIG. 7 is a flowchart which represents a processing procedure of an interactive operation control unit 24;

FIG. 8 is a flowchart which represents a processing procedure of a reproduction handler 22;

FIG. 9 is a flowchart which represents a processing procedure of a re-encoding handler 23;

FIG. 10 is a flowchart which represents a processing procedure of a time-sharing control unit 25;

FIG. 11 is an internal configuration of the HD recorder 100 according to the second embodiment;

FIG. 12 is a timing diagram which shows the status transitions of a record buffer 31, a re-encode buffer 32, and a track buffer 6 in FIG. 11;

FIG. 13 is a flowchart which represents a processing procedure of the record buffer 31;

FIG. 14 is a flowchart which represents a processing procedure of the re-encode buffer 32;

FIG. 15 is a flowchart which represents a processing procedure of a time-sharing control unit 25; and

FIG. 16 is a synthetic screen which is generated in the view buffer 8.

### DESCRIPTION OF THE PREFERRED EMBODIMENTS

<The First Embodiment>

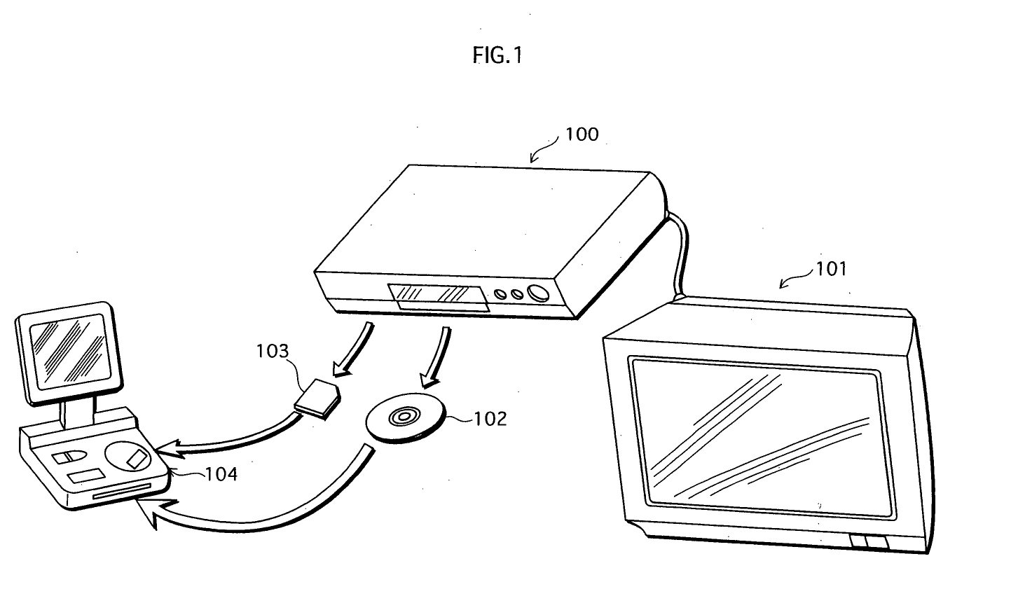

The following describes a recording apparatus according to preferred embodiments of the present invention. Firstly, an embodiment for usage is described. The recording apparatus according to the preferred embodiment is a HD recorder, and it is used by a user with a system represented by FIG. 1, including a HD recorder 100, a TV set 101, a DVD 102, a SD card 103, and a portable player 104.

The HD recorder 100 is an apparatus which receives broadcast content in the analog broadcast signal format, converts the format of the content into the MPEG2 format, and writes the converted content into a HDD. The HD recorder can reproduce the broadcast content which is written into the HD. Also, the HD recorder 100 can write broadcast content which is the same content as the content in the HDD into the SD card 103 or the DVD 102.

The TV set 101 displays the reproduction outputted by the HD recorder 100.

The DVD 102 is a portable medium in which the same content as the content recorded in the HDD included in the HD recorder 100 is to be recorded. The difference between the content recorded in the HDD included in the HD recorder 100 and the content which is to be recorded in the DVD 102 is an allocated bit rate for a movie stream. The allocated bit rate of the broadcast content recorded in the DVD 102 is lower than that of the content recorded in the HDD included in the HD recorder 100. Therefore, the picture quality of the broadcast content recorded in the DVD 102 is sometimes worse than that of the content recorded in the HDD 4 included in the HD recorder 100.

The SD card 103 is a portable medium in which the same content as the content recorded in the HDD included in the HD recorder 100 is to be recorded. The difference between the content recorded in the HDD included in the HD recorder 100 and the content which is to be recorded in the SD card 103 is the format of the recorded movie stream. The movie stream of the broadcast content recorded in the HDD included in the HD recorder 100 is MPEG2 while that of the broadcast content recorded in the SD card 103 is MPEG4. MPEG4 uses a lower encoding bit rate than MPEG2. Therefore, the picture quality of the broadcast content recorded in the SD card 103 is sometimes worse than that of the content recorded in the HDD 4 included in the HD recorder 100.

The portable player 104 is a portable apparatus which can reproduce broadcast content which is recorded in the DVD 102 or the SD card 103. The user can view the same content as the content recorded in the HDD outside the house by bringing out the portable player.

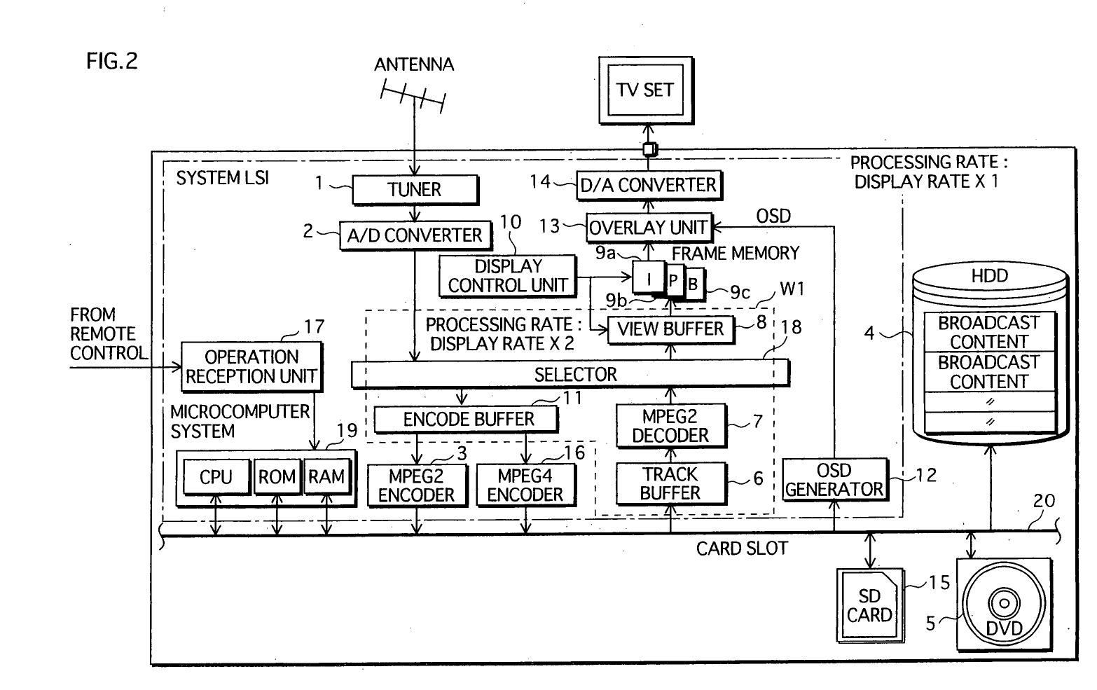

The above is the description of the embodiment for the usage of the HD recorder 100. Secondly, the following is the embodiment for production of the HD recorder 100. The HD recorder 100 mainly includes a system LSI and a drive apparatus, and can be industrially produced by installing these components in the cabinet of the HD recorder. The system LSI is an integrated circuit in which various processing units for performing the function of the HD recorder 100 are integrated. The recording apparatus which is produced in the way described above includes an internal configuration represented by FIG. 2.

As represented by FIG. 2, the HD recorder 100 includes a tuner 1, an A/D converter 2, a MPEG2 encoder 3, a HDD 4, a DVD drive 5, a track buffer 6, a MPEG2 decoder 7, a view buffer 8, a frame memory 9a, 9b, 9c, a display control unit 10, an encode buffer 11, an OSD generator 12, an overlay unit 13, a D/A converter 14, a card slot 15, a MPEG4 encoder 16, an operation reception unit 17, a selector 18, a microcomputer system 19, and a bus 20. A MPEG2 encoder 3, a HDD 4, a DVD drive 5, a track buffer 6, a MPEG4 encoder 16, and a microcomputer system 19 are interconnected to the bus 20 using bus topology. The difference between the configuration in FIG. 2 and a common configuration of a recording apparatus is the components in a box “w1”. In FIG. 2, the operating frequency of the components in the box “w1” is different from that of the other components. The operating frequency-of the components in the box “w1” is twice as high as that of the other components. That is because the components in the box “w1” are designed to perform at an operating frequency which is twice as high as a display rate of the TV set, while the other components are designed to perform at the same rate as the display rate of the TV set. The components in the box “w1” are collectively called “the high-speed processing unit”.

The tuner 1 demodulates a broadcast wave, selects a channel, and outputs broadcast content in the analog broadcast signal format.

The A/D converter 2 converts the broadcast content in the analog broadcast signal format into the content in the uncompressed digital format.

The MPEG2 encoder 3 encodes the broadcast content in the uncompressed digital format into the content into the MPEG2 format using the MPEG2 standard. Broadcast content in the MPEG2 format includes files each of which is called a VOB. The encoding by the MPEG2 encoder 3 is performed on each picture data which is for a length of 0.4 to 1.0 seconds. A GOP (Group of Picture) is a group of the picture data, and each of the picture data is for a length of 0.4 to 1.0 seconds. The minimum encoding unit is called a VOBU, which includes a GOP and a plurality of audio frames which are to be reproduced at the same time as the GOP is reproduced.

The HD drive (HDD) 4 is a drive apparatus which reads /writes a VOBU from/into the storage area of the HD. The function of the HDD 4 is to write a VOBU which is transferred from the MPEG2 encoder 3 via the bus 20 into the HD, to read broadcast content recorded in the HD and to transfer the read content to the bus 20, and so on.

The DVD drive 5 is a drive apparatus which accepts DVD 102, and reads/writes a VOBU from/into the DVD 102. The function of the DVD drive 5 is to write a VOBU which is transferred from the MPEG2 encoder 3 via the bus 20 into the DVD, to read broadcast content recorded in the DVD and to transfer-the read content to the bus 20, and so on.

The track buffer 6 is a buffer for storing a VOBU which is read from the HDD 4 or the DVD drive 5, and outputs the VOBU to the MPEG2 decoder 7. The track buffer 6 acts as holding area between the bus 20 and the MPEG2 decoder 7, and absorbs the difference between the transferring rate of the bus 20 and the processing rate of the MPEG2 decoder 7.

The MPEG2 decoder 7 extends a VOBU to convert the format of the VOBU into the uncompressed digital format. More specifically, the MPEG2 decoder 7 performs processing, such as VLD (Variable Length Decode), IQ (Inverse Quantization), IDCT (Inverse Discrete Cosine Transform), and MC (Motion Compensation) on Bidirectionally Predictive (B) pictures, Predictive (P) pictures, Intra (I) pictures to obtain picture data in the digital uncompressed format, and writes the obtained data into the view buffer 8 or the encode buffer 11.

The view buffer 8 stores a plurality of the picture data in the digital uncompressed format, which are obtained through the decoding by the MPEG2 decoder 7, and outputs each picture data to the frame memory 9a, 9b, and 9c one by one. The view buffer 8 absorbs the difference of the processing speed between the MPEG2 decoder 7, belonging to the high-speed processing unit, and the frame memory 9a, 9b, and 9c, existing outside the high-speed processing unit.

The frame memory 9a, 9b, and 9c are assigned to store three types of picture data, which are “I pictures”, “B pictures”, and “P pictures” respectively, and each of the frame memories separately stores the assigned picture data in the uncompressed format, which is obtained through the extension of the three types of the picture data.

The display control unit 10 reads the plurality of the picture data from the view buffer 8, and writes the picture data into the frame memory 9a, 9b, and 9c. Then, the display control unit sequentially reads the uncompressed picture data stored in the frame memory 9a, 9b, and 9c in an order indicated by the PTS (Presentation Time Stamp), which is added to the picture data, and outputs the picture data after converting the data into a video signal. In the MPEG2 format, a plurality of the picture data are set in an order which is called the encoding order. To be reproduced, the picture data has to be rearranged in the displaying order, which is why the display control unit sequentially reads the picture data in the order indicated by the PTS.

The encode buffer 11 is a buffer for storing a plurality of the picture data in the uncompressed digital format obtained through the decoding by the MPEG2 decoder 7, and outputs each of the picture data one by one to the MPEG2 encoder 3 or the MPEG4 encoder 16. The encode buffer 11 absorbs the difference of the processing speed between the MPEG2 decoder 7, belonging to the high-speed processing unit, and the MPEG2 encoder 3 or the MPEG4 encoder 16, existing outside the high-speed processing unit.

The OSD generator 12 generates an OSD according to an instruction from the microcomputer system 19. The OSD is simplified graphics which are drawn using colors indicated by a Look Up table (LUT), having 24 colors for instance, as the background color and the text color. The OSD is generated every time it is needed, and can be freely redrawn according to the user's instructions. The HD recorder 100 shows the information of broadcast content using the OSD, and redraws the OSD according to the user's operation. This realizes interactive operations by the HD recorder 100.

The overlay unit 13 outputs, to the TV set 101, broadcast content in the uncompressed digital format overlaid with an OSD. The overlay unit 13 performs the overlay by blending horizontal lines included in each picture data and in the OSD. Depending on the blending rate, the OSD can cover up the picture data or can be transparent.

The D/A converter 14 converts broadcast content in the uncompressed digital format into broadcast content in the analog video signal format.

The card slot 15 accepts the SD card 103.

The MPEG4 encoder 16 obtains broadcast content in the MPEG4 format by encoding broadcast content in the uncompressed digital format using the MPEG4 standard. The following two types of broadcast content are targeted by the MPEG4 encoder 16:

(i) Broadcast content in the uncompressed digital format which is converted by the A/D converter 2 from broadcast content in the analog broadcast signal format;

(ii) Broadcast content in the uncompressed digital format which is converted by the MPEG2 decoder 7 from broadcast content in the MPEG2 format which is once recorded in the HDD.

The former encoding is performed when the SD card is selected as a recording location, and the latter is performed when broadcast content which is once recorded in the HD is re-encoded and copied. The broadcast content obtained through the encoding by the MPEG4 encoder 16 is written into the SD card 103 which is inserted in the card slot 15.

The operation reception unit 17 receives user's instructions which are accepted by a remote control or the front panel of the HD recorder 100.

The selector 18 outputs broadcast content in the analog broadcast signal format, which is outputted by the tuner 1, to the encode buffer 11. This operation is controlled by the microcomputer system 19. The selector 18 also outputs the output from the MPEG2 decoder 7 to the view buffer 8 or the encode buffer 11.

The microcomputer system 19 is a common computer system, which includes a CPU, a ROM in which programs are stored, and a RAM. The programs in the ROM are read by the CPU, and the programs and hardware resources cooperate to realize calculations and processing for achieving objects.

In the HD recorder 100 with above-described configuration, the MPEG2 decoder 7, belonging to the high-speed processing unit, and the other components are different in the operating frequency, and they need to be asynchronously controlled.

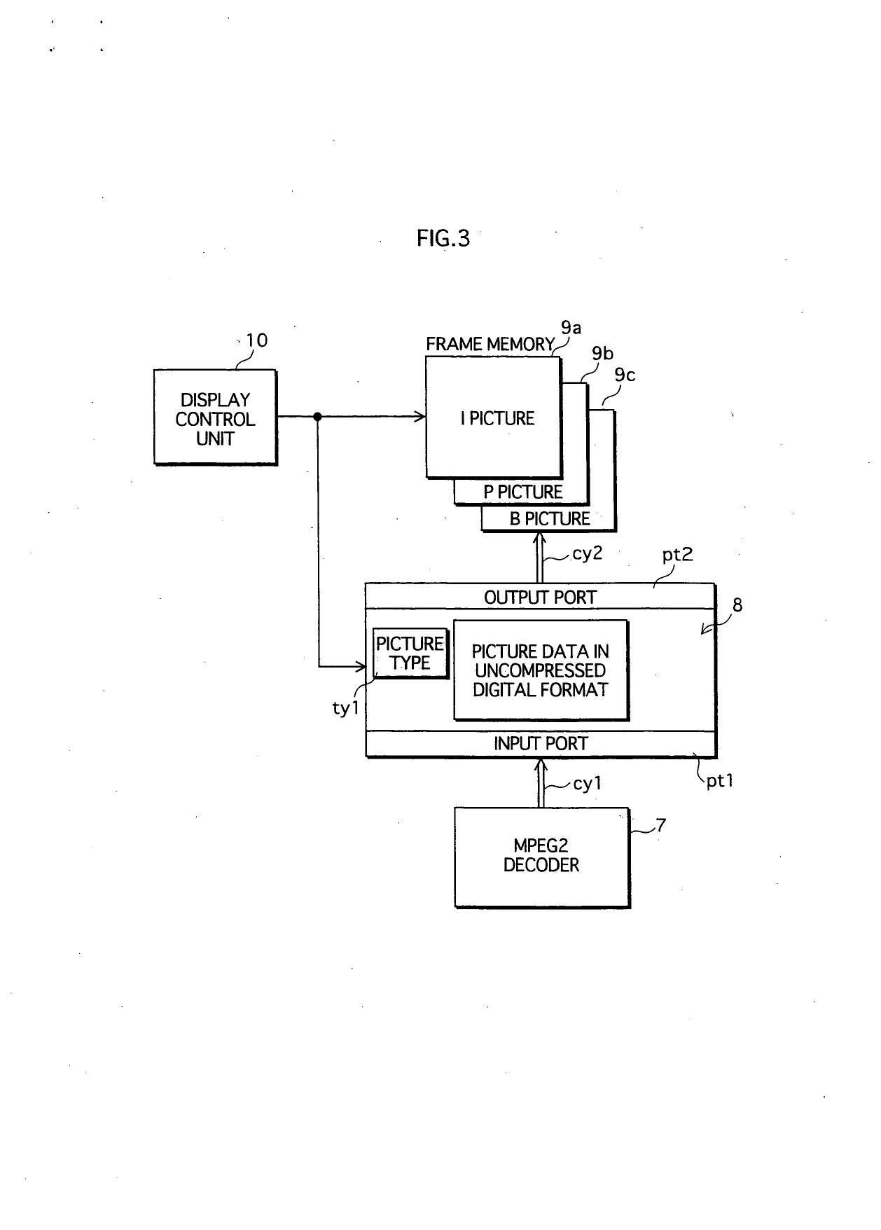

The following is a description of the asynchronous control with reference to FIG. 3. In FIG. 3, the MPEG2 decoder 7, the view buffer 8, the frame memory 9a, 9b, 9c, and the display control unit 10 are abstracted from the internal configuration of the recording apparatus and enlarged for description. Picture data in the uncompressed format obtained through the decoding by the MPEG2 decoder 7 is once stored in the view buffer 8 and written into the frame memory 9a, 9b, and 9c as described above. The configuration in FIG. 3 is different from the configuration of a common HD recorder in that the view buffer 8 acts as holding area between the MPEG2 decoder 7 and the frame memory 9a, 9b, and 9c. Each of the frame memory 9a, 9b, and 9c is a D-RAM or a SD-RAM. In common recording apparatus, picture data in the uncompressed digital format, which is obtained through the decoding by the MPEG2 decoder 7, is written into the frame memory 9a, 9b, or 9c. In the HD recorder 100 according to this embodiment of the present invention is different from a common recorder in that the MPEG2 decoder 7 belongs to the high-speed processing unit and it operates at a processing rate which is twice as high as the display rate of the TV. The operation frequency is different between the frame memory 9a, 9b, 9c and the MPEG2 decoder 7, because the frame memory 9a, 9b, and 9c are needed to perform at the same operating rate as the display rate of the TV. To absorb the difference between the operation frequencies, the view buffer 8 is-set between the MPEG2 decoder 7 and the frame memory 9a, 9b, and 9c. The view buffer 8 is a dual port memory with the input port “pt1” which is connected to the MPEG2 decoder 7 and the output port “pt2” which is connected to the frame memory 9a, 9b, and 9c. The MPEG2 decoder 7 writes picture data in the uncompressed digital format with picture type information “ty1” into the view buffer 8 through the input port “pt1” as indicated in FIG. 3 by an arrow “cy1”. The picture type information “ty1” indicates which type of the picture data the picture data in the uncompressed digital format is among “I picture”, “P picture” and “B picture”.

The display control unit 10 reads picture data in the uncompressed digital format through the output port of the recording apparatus as indicated in FIG. 3 by an arrow “cy2”, and writes the picture data into the frame memory 9a, 9b, or 9c.

When reading the picture data, the display control unit 10 refers to the picture type information “ty1”, and writes the read picture data into one frame memory among the frame memory 9a, 9b, and 9c according to the picture type information “ty1”. In the case the picture type is “I picture”, the picture data in the uncompressed digital format which is stored in the view buffer 8 is written into the frame memory 9a, which is for storing “I picture”. In the case the picture type is “P picture”, the picture data in the uncompressed digital format which is stored in the view buffer 8 is written into the frame memory 9b, which is for storing, “P picture”. In the case the picture type is “B picture”, the picture data in the uncompressed digital format which is stored in the view buffer 8 is written into the frame memory 9c, which is for storing “B picture”. The picture data in the uncompressed digital format written in the frame memory 9a, 9b, and 9c is read at the display rate and displayed by the TV set 101.

The asynchronous control by the HD recorder 100 is realized in the above-described process of reading and writing by the view buffer 8.

The following is a description of how the storage capacity which the view buffer has to have is calculated. Note that the decoded picture data has to be kept in the uncompressed format. When data amount per pixel is 3 bytes and the number of pixels is 720×480 pixels per horizontal and vertical line, the storage capacity which is needed to keep the uncompressed picture data is 1036800 bytes (=720×480×3). Although “I pictures”, “P pictures” and “B pictures” are stored all together in the view buffer in this embodiment, three view buffers may be set up for storing “I pictures”, “P pictures” and “B pictures” separately. In this case, a dual port memory of 3110400 bytes (1036800×3) is needed.

The above is the description of the configuration of the hardware resources of the HD recorder 100. The following is the configuration of software resources of the HD recorder 100.

As described above, the programs read from the ROM and the hardware resources cooperate to realize calculations and processing for achieving objects in the HD recorder 100. The objects here include recording, reproduction, copying, and interactive operations. This unique information-processing equipment (the HD recorder 100) for achieving the objects is constructed from concrete means, and the means are embodied by the cooperation among programs and hardware resources (the HD 1 to the selector 18) for realizing calculations and processing to achieve the objects.

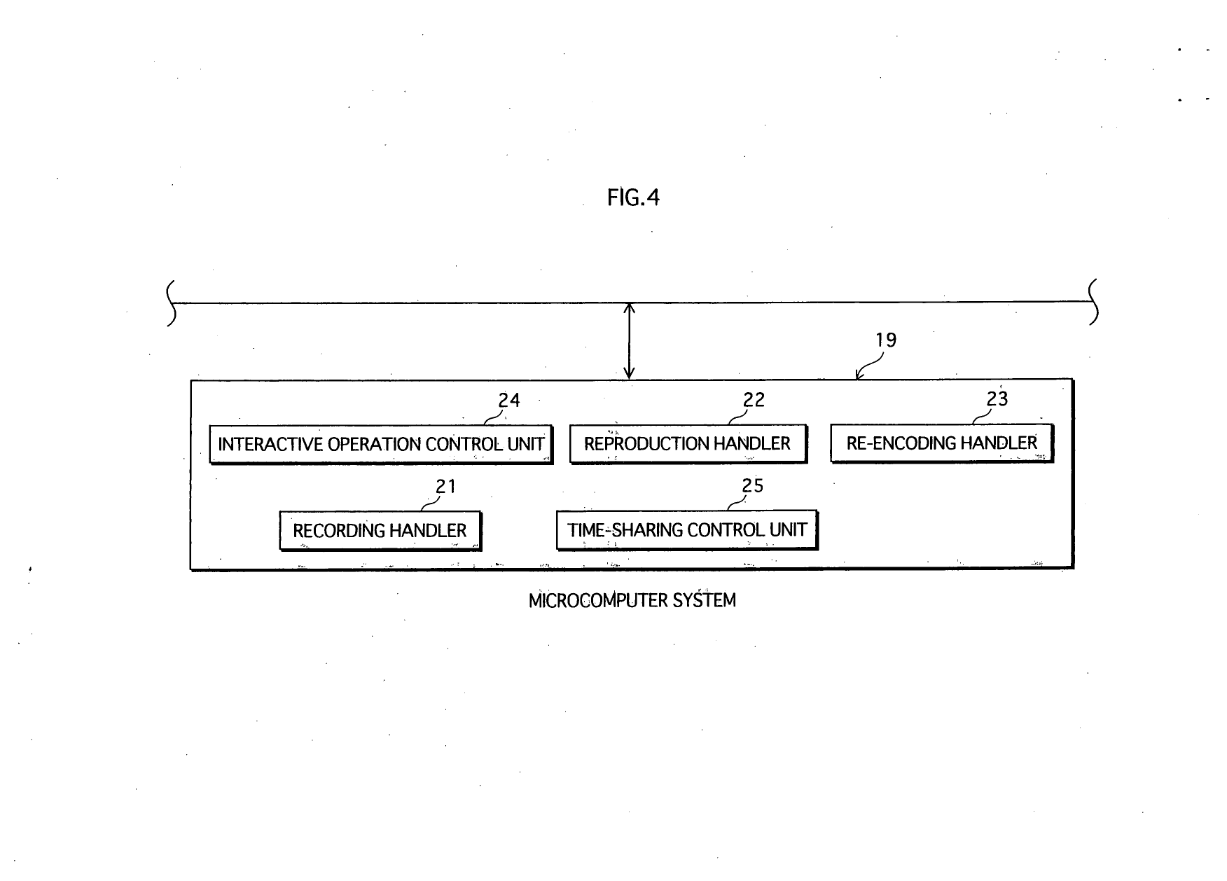

FIG. 4 is a functional block diagram which represents the concrete means embodied by the cooperation among the programs stored in the ROM of the microcomputer system 19 and the hardware resources. A recording handler 21, a reproduction handler 22, a re-encoding handler 23, an interactive operation control unit 24, and a time-sharing control unit 25 are included in the diagram.

The recording handler 23 realizes a recording control. The recording control means the following operations: to convert broadcast content in the analog signal format into content in the uncompressed digital format and write the converted content into the encode buffer 11; to instruct the selector 18 to switch the input source, which is to be encoded, to the encode buffer 11; to instruct the MPEG2 encoder 3 for encoding the picture data in the encode buffer 11; and to write the encoded data into the HDD 4.

The reproduction handler 22 realizes a reproduction control. The reproduction control means the following operations: to decode broadcast content in the MPEG2 format with the MPEG2 decoder 7; to write the decoded content into the view buffer; and to output the decoded content to the display control unit 10 at the display rate of TV set 101.

The re-encoding handler 23 realizes a re-encoding control. The re-encoding control means the following operations: to decode the broadcast content in the MPEG2 format with the MPEG2 decoder 7; to write the decoded content into the encode buffer 11; and to encode the decoded content with the MPEG2 encoder 3 or the MPEG4 encoder 16. The re-encoding is performed to reduce the size of broadcast contents in the MPEG2 format and to change the encoding format of the broadcast content from MPEG2 to MPEG4.

The interactive operation control unit 24 controls interactive operations for the recording apparatus. The control of interactive operations by the interactive operation control unit 24 is realized by using an OSD called “Content Navigation” which is generated by the OSD generator 12 and overlaid by the overlay unit 13. The Content Navigation is a GUI (Graphical User Interface) which graphically represents indications for broadcast content recoded in the HDD 4. The user can chose the broadcast content which is to be controlled by the reproduction handler 22 or to be controlled by the re-encoding handler 23 by giving instructions through the Content Navigation.

The time-sharing control unit 25 realizes time-sharing between the re-encoding control and the reproduction control. The reason why the time-sharing is needed is that in both cases of the re-encoding and the reproduction, content in the MPEG2 format has to be decoded by the MPEG2 decoder 7. In other words, the reproduction control and the re-encoding control conflict for the use of the MPEG2 decoder. 7. The MPEG 2 decoder 7 is set in the high-speed processing unit and performs at the processing rate twice as high as the other components for the purpose of realizing the time-sharing between the re-encoding control and the reproduction control, which is performed by the time-sharing control unit 25.

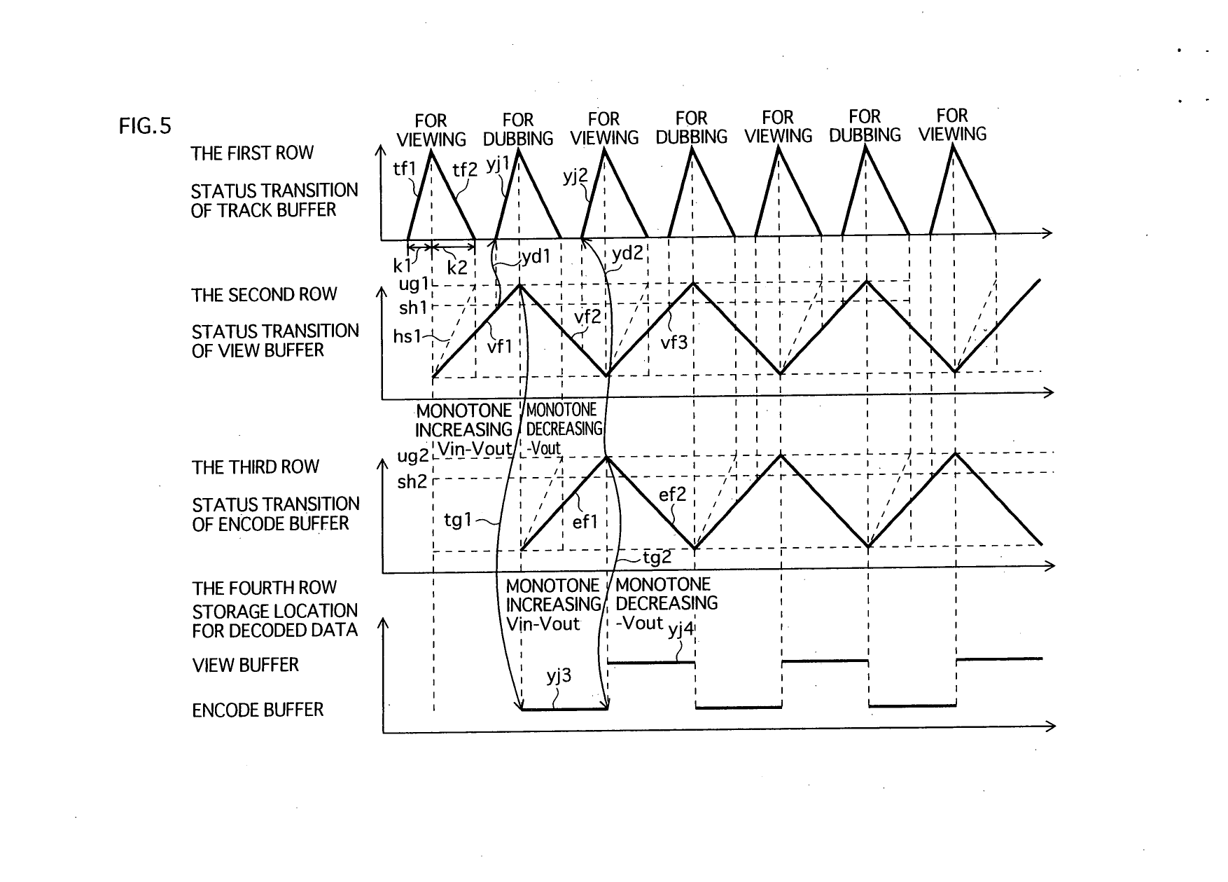

The time-sharing control by the time-sharing control unit 25 between the re-encoding control and the reproduction control is performed based on the status transitions of the track buffer 6, view buffer 8, and the encode buffer 11. The following is a description of how the time-sharing control based on the status transitions is performed, with reference to FIG. 5. FIG. 5 is a timing diagram which shows the status transitions of the track buffer 6, the view buffer 8, and the encode buffer 11 of FIG. 2. The diagram also shows the timing of the switch between the reproduction control and the re-encoding control. In FIG. 5, the status transitions are represented by a line graph of which the horizontal axis represents a time scale and the vertical axis represents a scale for the amount of accumulated data.

The first row in FIG. 5 represents the status transition of the track buffer 6. As described in FIG. 5, the graph which represents the status transition of the track buffer 6 includes a monotone increasing “tf1”, which means that VOBU files are sequentially read from the DVD 5 into the track buffer 6, and a monotone decreasing “tf2”, which means that each picture data included in the read VOBU files is sequentially outputted. The slope of the monotone decreasing “tf2” is based on the output speed “Vout” from the track buffer 6 to the MPEG2 decoder 7, and the slope of the monotone increasing “tf1” is based on the difference between the input speed “Vin” from the DVD 5 to the track buffer 6 and the output speed “Vout” from the track buffer 6 to the MPEG2 decoder 7 (“Vin−Vout”). The input speed “Vin” of the track buffer 6 is equal to the reading speed from the HDD 4, and is much higher than the output speed “Vout” of the track buffer 6. Therefore, the track buffer 6 stores VOBU files in a short period (a period “k1”). On the other hand, the output speed “Vout” of the track buffer 6 is not as high as the “Vin”, however, is twice as high as the display rate of the TV set. This is because “Vout” of the track buffer is the same speed as the processing rate of the MPEG2 decoder 7. The track buffer 6 is to be emptied in a period “k2”, because the data is outputted from the track buffer 6 at the processing rate of the MPEG2, which belongs to the high-speed processing unit.

The second row in FIG. 5 represents the status transition of the view buffer 8. As described in FIG. 5, the graph for the status transition of the view buffer 8 includes a monotone increasing “Vf1”, which means that a plurality of the picture data obtained by the MPEG2 decoder 7 are sequentially stored in the view buffer 8, and a monotone decreasing “vf2”, which means that the picture data stored in the view buffer 8 is sequentially outputted to the frame memory 9a, 9b, and 9c. The slope of the monotone decreasing “vf2” is based on the output speed “Vout” from the view buffer 8 to the frame memory 9a, 9b, and 9c, and the slope of the monotone increasing “vf1” is based on the difference between the input speed “Vin” from the MPEG2 decoder 7 to the view buffer 8 and the output speed “Vout” from the view buffer 8 to the frame memory 9a, 9b, and 9c (“Vin−Vout”). Compared to “Vout” of the track buffer 6, the view buffer 8 originally accumulates the decoded data at the same speed as “Vout” of the track buffer 6, as represented by a broken line “hs”. However, the decoded data in the viewbuffer 8 is outputted at the speed represented by “Vout”, which means that the accumulation speed by the view buffer 8 is “Vin−Vout”. Meanwhile, “Vin” of the view buffer 8 is twice as high as the “Vout” of the view buffer 8, which means that the absolute value of “Vin−Vout” equals to the absolute value of “−Vout”. As a result, the slope of the monotone increasing is equal to the slope of the monotone decreasing in the status transition of the view buffer 8.

The third row in FIG. 5 represents the status transition of the encode buffer 11. As described in FIG. 5, the graph which represents the status transition of the encode buffer 11 includes a monotone increasing “ef1”, which means that a plurality of the picture data are sequentially stored in the encode buffer 11, and a monotone decreasing “ef2”, which means that the picture data stored in the encode buffer 11 is sequentially outputted to the MPEG2 encoder 3 or the MPEG4 encoder 16. The slope of the monotone decreasing “ef2” is based on the output speed “Vout” from the encode buffer 11 to the MPEG2 encoder 3 or the MPEG4 encoder 16, and the slope of the monotone increasing “ef1” is based on the difference between the input speed “Vin” from the MPEG2 decoder 7 to the encode buffer 11 and the output speed “Vout” from the encode buffer 11 to the MPEG2 encoder 3 or the MPEG4 encoder 16 (“Vin−Vout”).

Here, a VOBU which is read from the HDD 4 to be re-encoded is called a VOBU for dubbing, and a VOBU which is read from the tuner 1 only to be viewed is called a VOBU for viewing. The control by the time-sharing control unit 25 includes two types of control. The first control is to decide which is to be read from the HDD 4 between the VOBU for dubbing and the VOBU for viewing, and the second control is to decide to which between the view buffer 8 and the encode buffer 11 the decoded data obtained through the decoding by the MPEG2 decoder 7 is to be stored. The first target for the reading can be either the VOBU for dubbing or the VOBU for viewing. The second and later targets for the reading is decided when the accumulation in the view buffer 8 or the encode buffer 11 reaches a predetermined threshold value.

A threshold value “sh2” in the third row in FIG. 5 represents a trigger for reading the VOBU for viewing from the HDD 4. As represented by the threshold value “sh2”, when the accumulation in the encode buffer 11 reaches the threshold value “sh2”, the VOBU for viewing is read from the HDD4 into the track buffer 6, as represented by an arrow “yd2” and a line “yj2”. The accumulation in the view buffer 8 and the encode buffer 11 reaching the threshold value “sh1” and “sh2” means that the accumulation in the view buffer 8 and the encode buffer 11 is to reach the upper limit of the accumulation before long. The time-sharing control unit 25 is designed to read the VOBU for dubbing and the VOBU for viewing from the HDD 4 before the accumulation in each of the view buffer 8 and the encode buffer 11 reaches it's upper limit.

The storage location is decided when the accumulation in the view buffer 8 or the encode buffer 11 reaches it's upper limit. An upper limit “ug1” in the second row in FIG. 5 represents a trigger for switching the storage location, which is for the data decoded by the MPEG2 decoder 7, to the encode buffer 11. When the accumulation in the view buffer 8 reaches the upper limit “ug1”, the selector 18 is controlled to switch the storage location for the data decoded by the MPEG2 decoder 7 to the encode buffer 11, as indicated by an arrow “tg1” and a line “yj3” in the fourth row in FIG. 5. The accumulation in the encode buffer 11 increases through the control by the selector 18 (a monotone increasing “ef3” in the third row in FIG. 5).

An upper limit “ug2” in the third row in FIG. 5 represents a trigger for switching the storage location, which is for the data decoded by the MPEG2 decoder 7, to the view buffer 8. When the accumulation in the encode buffer 11 reaches the upper limit “ug2”, the selector 8 is controlled to switch the storage location for the data decoded by the MPEG2 decoder 7 to the view buffer 8, as indicated by an arrow “tg2” and a line “yj4” in the fourth row of FIG. 5. The accumulation in the view buffer 8 increases through the control by the selector 18 (a monotone increasing “vf3” in the second row in FIG. 5). The control described above is the time-sharing control by the time-sharing control unit 25.

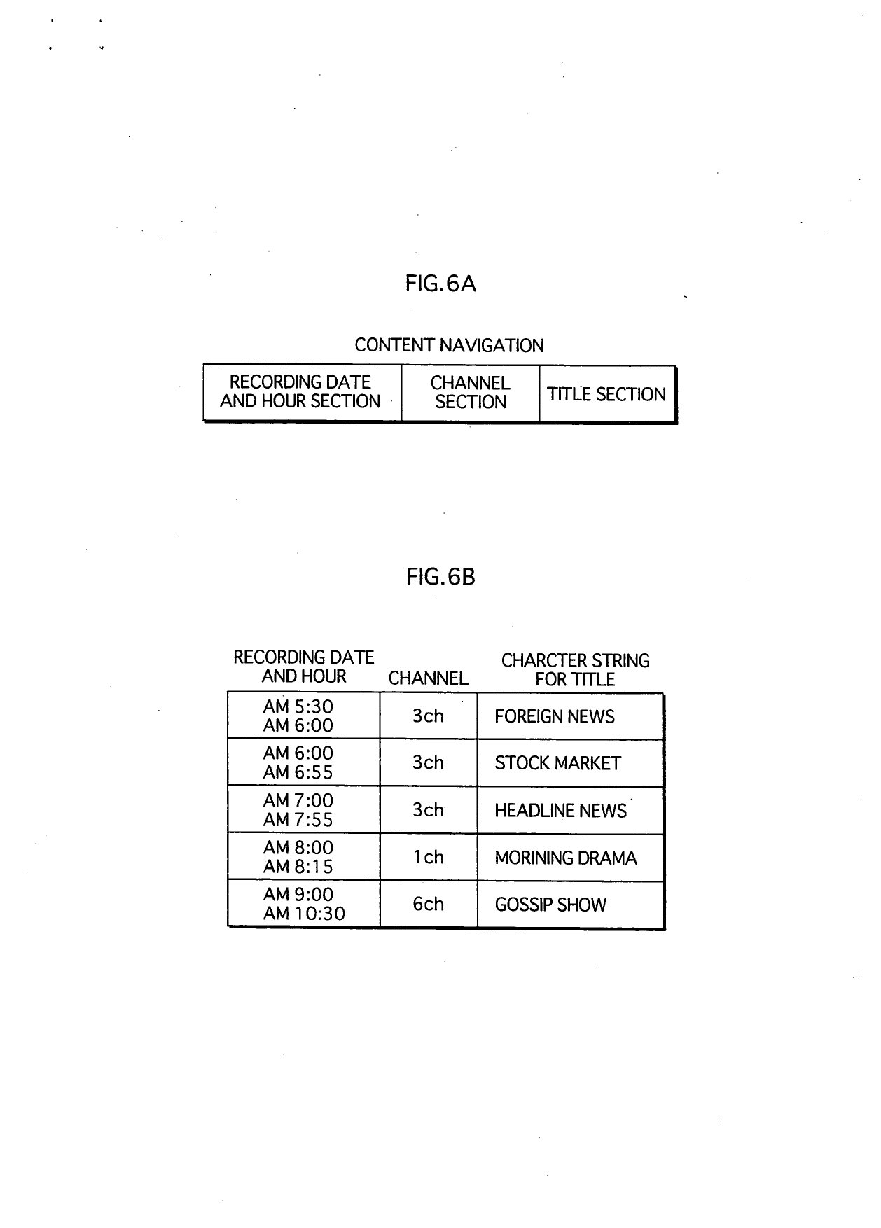

The control by the above-described recording handler 21 to interactive operation control unit 24 is realized mainly by programs which are stored in the ROM included in the microcomputer system 19. These programs realize the interactive reproduction control and the interactive re-encoding control through the Content Navigation. FIG. 6A is an example Content Navigation. As shown in FIG. 6A, the Content Navigation includes a recording date and hour section, a channel section, and a title section. A recording date and hour, a channel, and a title are described in a recording date and hour section, a channel section, and a title section respectively. The status of the Content Navigation changes according to the user's instruction received by the operation reception unit 17, because the Content Navigation is a GUI. Each item of the Content Navigation has two statuses, which are a normal status and a focused status. The normal status is a status in which an item of the Content Navigation is not selected by the user, and the focused status is a status in which an item of the Content Navigation is selected as an object of operations by the user using arrow keys of the remote control. A GUI environment, including an OSD and a remote control, is provided to the user by changing the status of each item of Content Navigation according to the instructions given by the user with the remote control. FIG. 6B represents an example Content Navigation with specific recording date and hours, channels, and titles. The above is the description of the concrete means embodied by the cooperation among programs included in the microcomputer system 19 and the hardware resources.

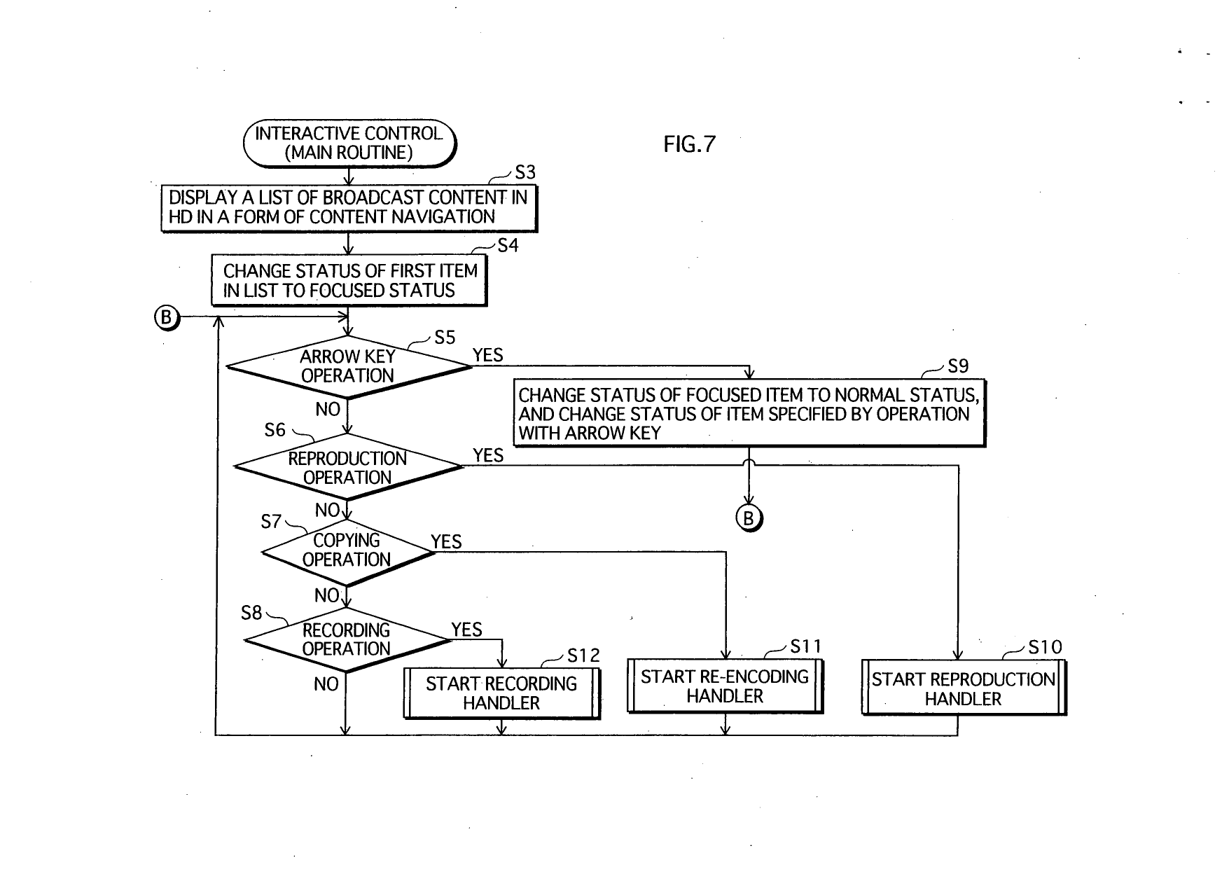

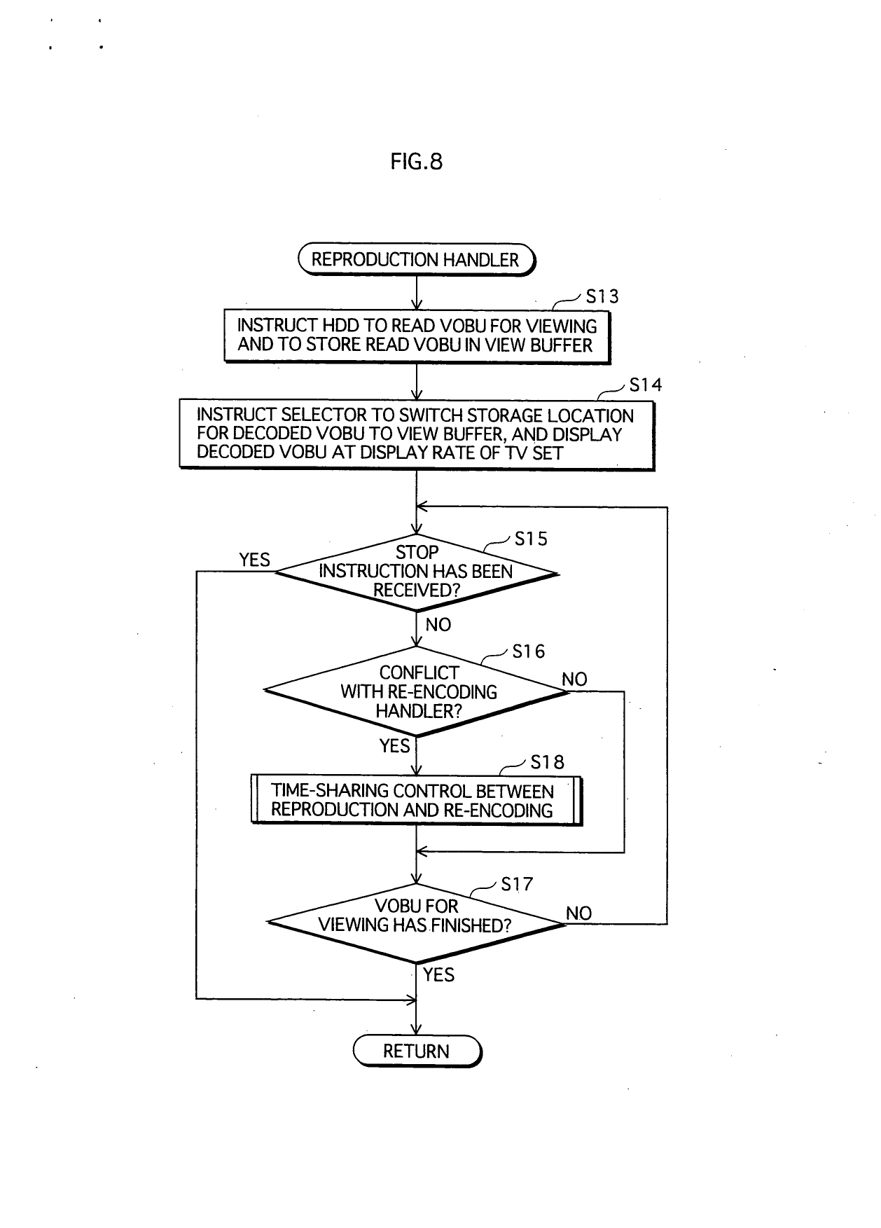

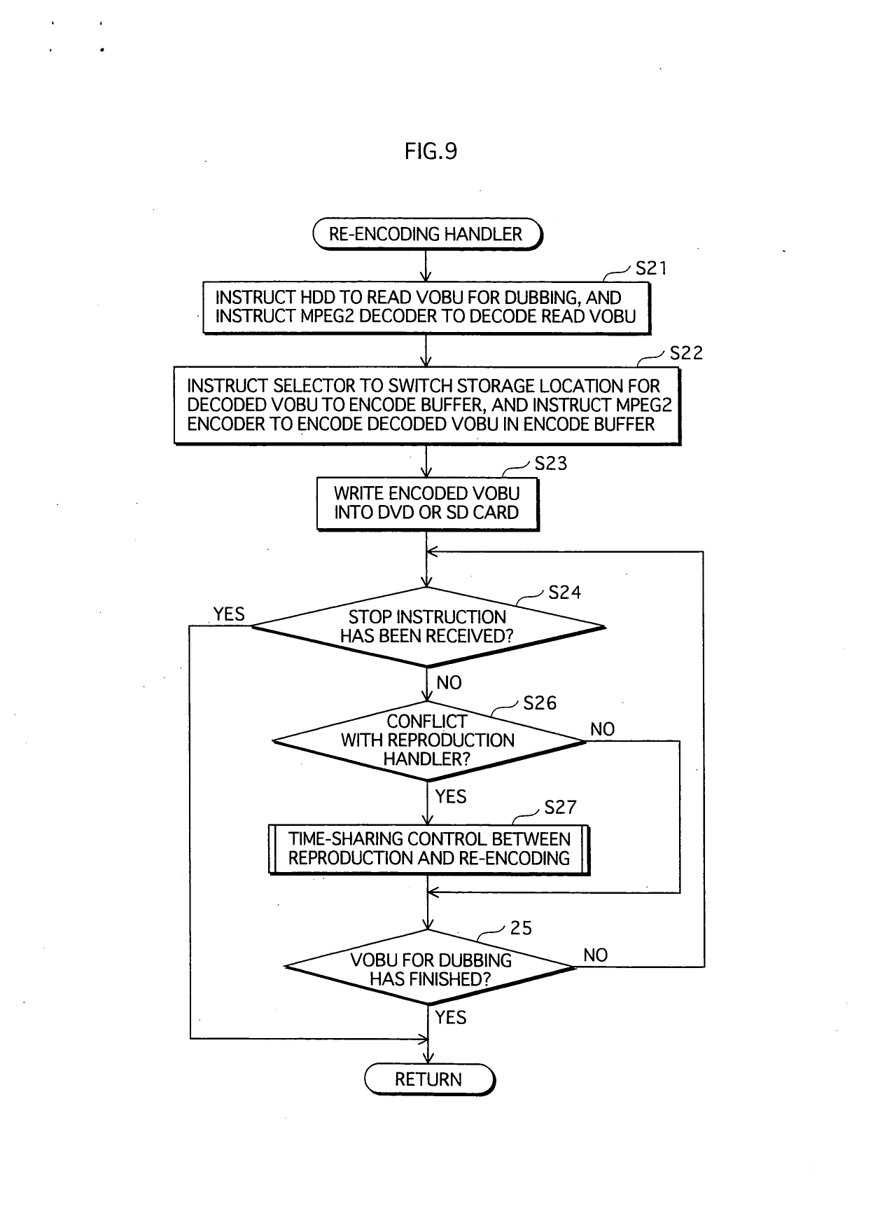

FIG. 7, FIG. 8, and FIG. 9 are flowcharts which represent the processing of the above-described program, and the reproduction handler 22 to the time-sharing control unit 25 are generated by writing the processing procedures represented by the flowcharts in computer language. The following is a description, with reference to the flowcharts, of the processing procedure of the reproduction handler 22 to the interactive operation control unit 24, which are controlled by the microcomputer system 19.

The interactive operation control unit 24 is substantially a routine program written in computer language for processing the procedure in FIG. 7. The following is the description of the processing procedure of the interactive operation control unit 24 with reference to the flowchart in FIG. 7. In the flowchart, a list of broadcast content in the HD is displayed in a form of Content Navigation (step S3), the status of the fist item in the list is changed to the focused status (step S4), and then, a procedure which consists of step S5 to step S8 is repeated as a loop for waiting an event.

When an arrow key of the remote control is pressed (“YES” in step S5), the status of the focused item is changed to the normal status, the status of the item specified by the operation with the arrow key is changed to the focused status (step S9), and the processing returns to the step S5 to S8. The status of each item in the list changes according to the operation by pressing arrow keys. An item of the list whose status is the focused status is called “broadcast content y”

When a reproduction operation is selected (“YES” in step S10), the reproduction handler 22 is started to reproduce broadcast content (step S10), and the processing returns to the loop for waiting an event which consists of the step S5 to S8.

When a copying operation is selected (“YES” in step S7), the re-encoding handler 23 is started to copy the broadcast content y (step S11), and the processing returns to the loop for waiting an event which consists of the step S5 to S8.

When a recording operation is selected (“YES” in step S8), the recording handler 21 is started to newly record broadcast content in the HD (step S12), and the processing returns to the loop for waiting an event which consists of the step S5 to S8.

The above is the processing procedure of the interactive operation control unit 24. The following is a description of the processing procedure of the reproduction handler 22.

The reproduction handler 22 is substantially a subroutine program written in computer language for processing the procedure in FIG. 8. The following is the description of the processing procedure of the reproduction handler 22 with reference to the flowchart in FIG. 8. In the flowchart, the reproduction handler 22 instructs the HDD to read a VOBU for viewing and to store the read VOBU in the view buffer 6 (step S13), instructs the selector 18 to switch the storage location for the decoded VOBU to the view buffer 8, instructs the display control unit 10 to display the decoded VOBU in the view buffer 8 at the display rate of the TV set (step S14), and then, repeats a procedure which consists of step S15 to step S17 as a loop for waiting an event. This loop monitors events, which are whether a stop instruction has been received (step S15) and whether the VOBU for viewing has finished (step S17), and when one of these events occurs, the subroutine program finishes and the processing returns to the routine program which has called this subroutine program. While the reproduction handler 22 is working, the re-encoding handler 23 is also working. In the case where there is a conflict between the reproduction handler 22 and re-encoding handler 23 (“YES” in step 16), the reproduction handler 22 and the re-encoding handler 23 are controlled by the time-sharing control unit 25 (step S18).

The re-encoding handler 23 is substantially a subroutine program written in computer language for processing the procedure in FIG. 9. The following is the description of the processing procedure of the re-encoding handler 23 with reference to the flowchart in FIG. 9. In the flowchart, the re-encoding handler 23 instructs the HD to read the VOBU for dubbing, instructs the MPEG2 decoder 7 to decode the read VOBU (step S21), instructs the selector 18 to switch the storage location for the decoded VOBU to the encode buffer 11, instructs the MPEG2 encoder 3 to encode the decoded VOBU in the encode buffer 11 (step S22) and to write the encoded VOBU into the DVD 102 or the SD card 103 (step S23), and then repeats a procedure which consists of step S24 to S27 as a loop for waiting an event. This loop monitors events, which are whether a stop instruction has been received (step S24) and whether the VOBU for dubbing has finished (step S25), and when one of these events occurs, the subroutine program finishes and the processing returns to the routine program which has called the subroutine program. While the re-encoding handler 23 is working, the reproduction handler 22 is also working. In the case where there is the conflict between the re-encoding handler 23 and the reproduction handler 22 (“YES” in step S26), the reproduction and the re-encoding is controlled by the time-sharing control unit 25 (step S27).

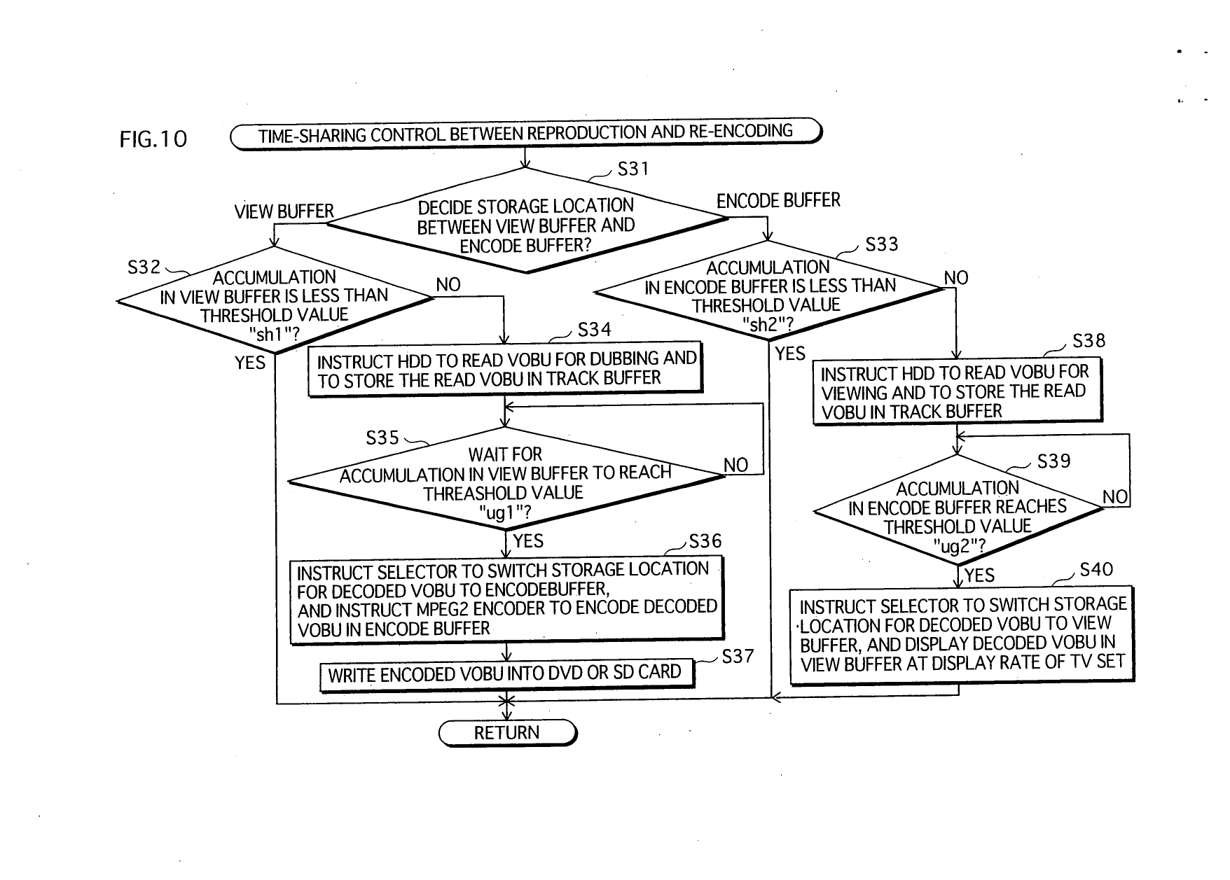

The time-sharing control unit 25 is substantially a subroutine program written in computer language for processing the procedure in FIG. 10. The following is the description of the processing procedure of the frame memory 9a, 9b, and 9c with reference to the flowchart in FIG. 10. In this processing procedure, the time-sharing control unit 25 decides that in which between the view buffer 8 and the encode buffer 11 the content decoded by the MPEG2 decoder 7 is stored (step S31), and when the accumulation in the view buffer 8 is less than the threshold value “Sh1” (step 32) or the accumulation in the encode buffer 11 is less than the threshold value “sh2” (step S33), the processing returns without executing any processing to the routine program which has-called this subroutine program (the re-encoding handler 23 or the reproduction handler 22).

In the case where step S32 or step S33 is “NO”, the time-sharing control unit 25 changes the target of the decoding and the storage location for the decoded content.

In the case where the accumulation in the view buffer 8 is not less than the threshold value “sh1” (“No” in step 32), the time-sharing control unit 25 instructs the HDD to read the VOBU for dubbing and to store the read VOBU in the track buffer 6 (step S34), then waits for the accumulation in the view buffer 8 to reach the threshold value “ug1” (step S35). When the accumulation in the view buffer 8 reaches the threshold value “ug1”, the time-sharing control unit 25 instructs the selector 18 to switch the storage location for the decoded VOBU to the encode buffer 11, instructs the MPEG2 encoder 3 to encode the decoded VOBU in the encode buffer 11 (step S36). Then, the encoded VOBU is written into the DVD 102 or the SD card 103 (step S37), and the processing returns to the routine program which has called this subroutine program (the re-encoding handler 23 or the reproduction handler 22).

In the case where the accumulation in the encode buffer 11 is not less than the threshold value “sh2” (“NO” in step S33), the time-sharing control unit 25 instructs the HDD to read the VOBU for viewing and to store the read VOBU in the track buffer 6 (step S38), and waits for the accumulation in the encode buffer 11 to reach the threshold value “ug2” (step S39). When the accumulation in the encode buffer 11 reaches the threshold value “ug2”, the time-sharing control unit 25 instructs the selector 18 to switch the storage location for the decoded content to the view buffer 8, and displays the decoded content in the view buffer 8 at the display rate of the TV set (step S40).

The decoding of the VOBU for viewing and the decoding of the VOBU for dubbing can be executed in parallel by switching the target of the decoding and the storage location as described above.

With the above-described embodiment, by making the processing rate of the MPEG2 decoder 7 twice as high as the display rate for outputting the reproduction, the decoding of the VOBU for dubbing and the VOBU for viewing can be executed in parallel. The decoded VOBU for viewing, which is obtained as described above, is once stored in the view buffer 8. As a result, the decoded VOBU for viewing, which is generated at the rate which is twice as high as the normal rate, is outputted at the original rate for reproduction. This allows the user to view broadcast content in the HDD 4 while a dubbing of other content from the HDD 4 to the DVD 102 or the SD card 103 accompanied by re-encoding is executed.

Note that the processing rate of the MPEG2 decoder 7 in the embodiment above is twice as high as the normal rate, but the rate may be 1.5 times or 1.8 times as high as the normal rate. For instance, when the processing rate of the MPEG2 decoder 7 is 1.5 times as high as the normal rate, the processing rate of the MPEG2 decoder 7 may be divided in the portion of 1.0:0.5. In this case, the re-encoding takes more than the actual time of the content. In other words, when the reproduction time of the content is 1 hour, the re-encoding takes 2.0 hours, which is 2.0 times as long as the reproduction time. However, it is a considerable merit for the user in that the user can view other content during the re-encoding.

<The Second Embodiment>

In the first embodiment, the conflict for the use of the MPEG2 decoder 7 between the reproduction control and the re-encoding control is resolved by the time-sharing control. However, the MPEG2 decoder 7 is not the only hardware resource which causes conflict. In the case of recording, a conflict for the use of the MPEG2 encoder 3 or the MPEG4 encoder 16 between the recording control and the re-encoding control may occur. This conflict occurs when the encoding format for the recoding is the same format as the encoding format for the re-encoding. For instance, in the case where the encoding format for recording is MPEG2 and the encoding format for re-encoding is MPEG2 as well, the conflict occurs.

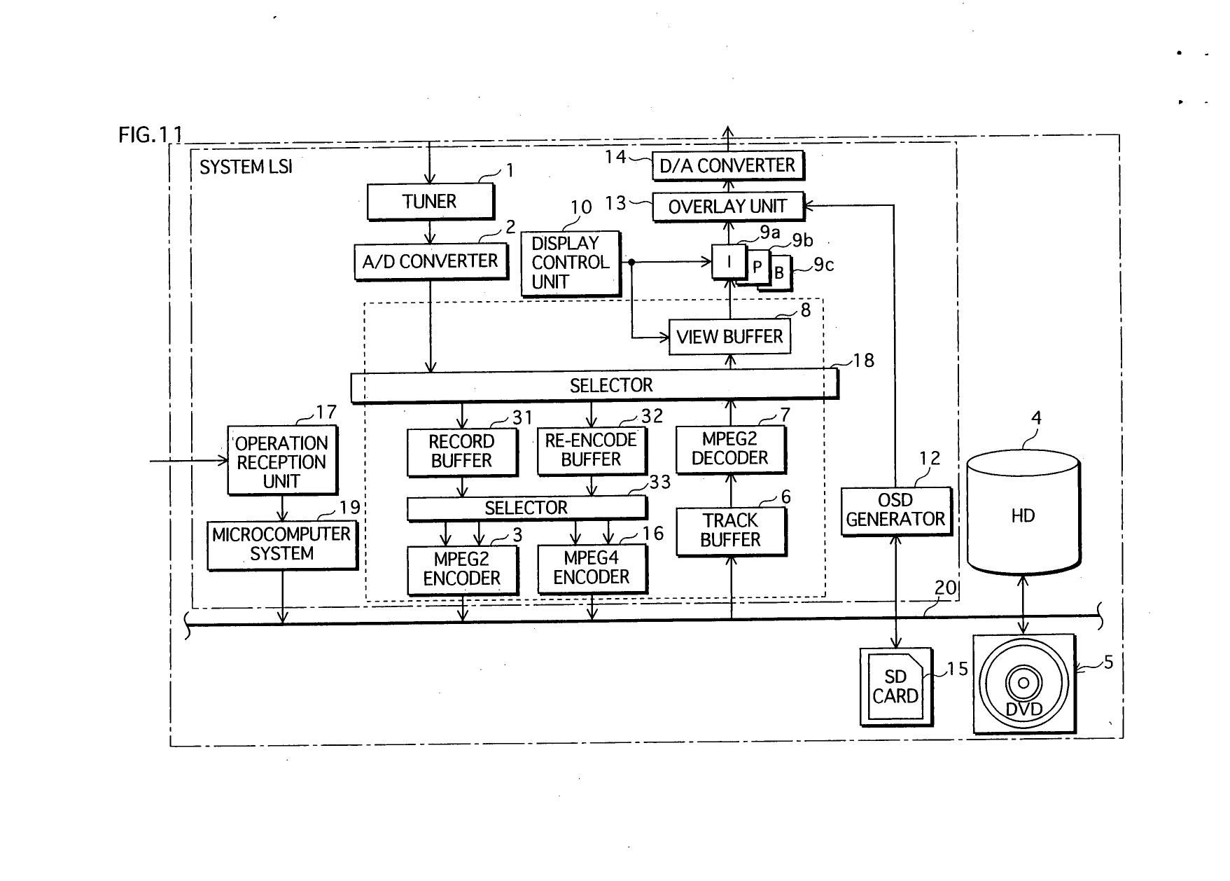

In the second embodiment, the time-sharing control unit 25 realizes time-sharing between the encoding for recording and the encoding for re-encoding, both of which are performed by the MPEG2 encoder 3. FIG. 11 shows an internal configuration of the recording apparatus according to the second embodiment.

The difference between FIG. 11 and FIG. 3 is that in FIG. 11 the MPEG2 encoder 3 and the MPEG4 encoder 16 belong to the high-speed processing unit, the encode buffer 11 is replaced by a record buffer 31 and a re-encode buffer 32, and a selector 33 is added. The MPEG2 encoder 3 and the MPEG4 encoder 16 perform encoding at the rate which is twice as high as the normal rate because they belong to the high-speed processing unit. Note that only MPEG2 encoder 3 is described here for simplification.

The record buffer 31 is a buffer which stores a plurality of picture data obtained through A/D conversion by the A/D converter 2 of broadcast content in the analog signal format, and outputs the converted content to the to the MPEG2 encoder 3 or the MPEG4 encoder 16 via the selector 33. The record buffer 31 absorbs the difference of the processing speed between the MPEG2 encoder 3 and the MPEG4 encoder 16, belonging to the high-speed processing unit, and the A/D converter 2, existing outside the high-speed processing unit.

The re-encode buffer 32 is a buffer which stores broadcast content in the uncompressed digital format which is obtained through the decoding by the MPEG2 decoder 7 of broadcast content in the MPEG2 format which is recorded in the HDD 4 or the DVD drive 5, and outputs the decoded content to the MPEG2 encoder 3 or the MPEG4 encoder 16 via the selector 33.

The selector 33 selectively outputs the broadcast content in the uncompressed digital format which is stored in the record buffer 31 and the re-encode buffer 32 to the MPEG2 encoder 3 or the MPEG4 encoder 16. The above is the difference between the recording apparatus according to the first embodiment and that according to the second embodiment.

The following is the description of control which is realized in the second embodiment by concrete means embodied by the cooperation among programs stored in the ROM and the hardware resources. The time-sharing control unit 25 in the second embodiment performs time-sharing control not only between the reproduction control and the re-encoding control, but also between the re-encoding control and the recording control.

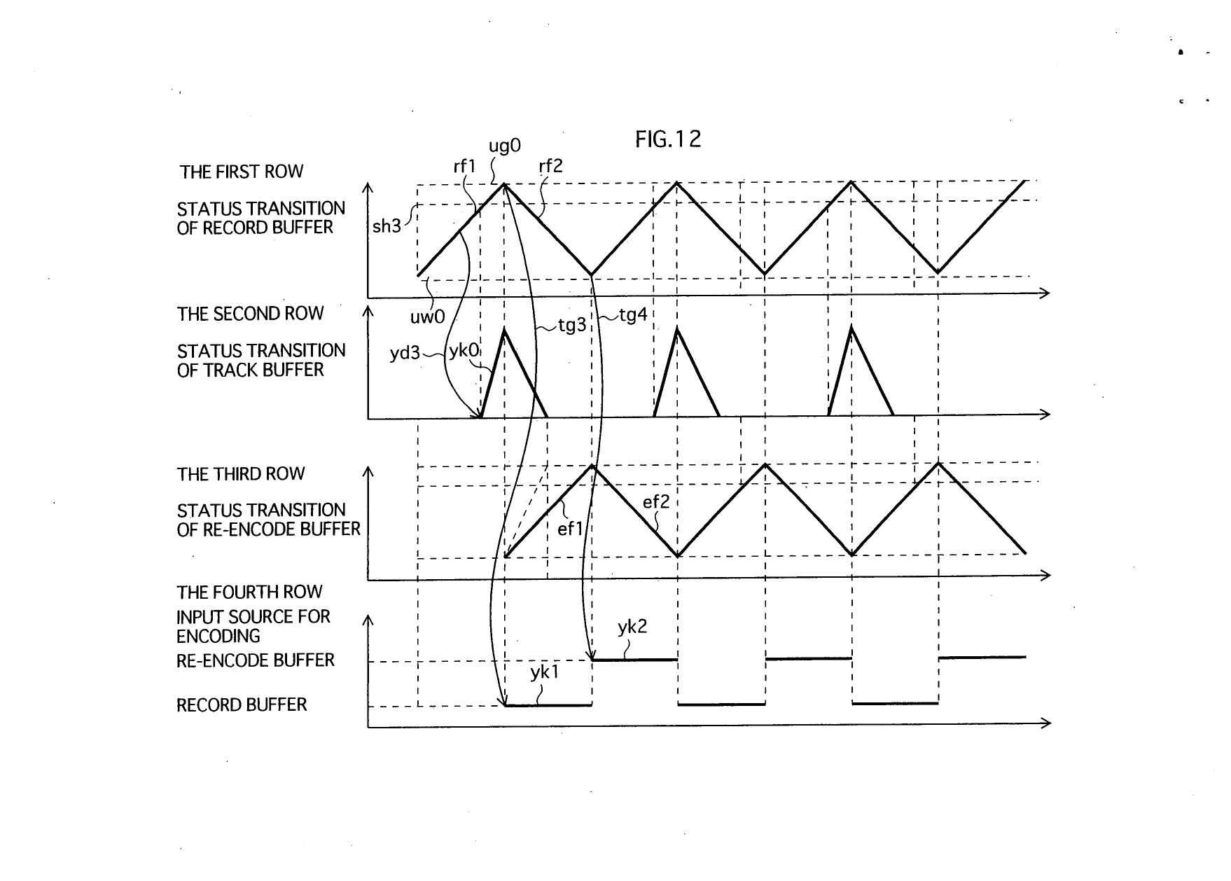

Here, the point to notice is that the encoding is performed by the MPEG2 encoder 3 in both cases of re-encoding and recording. However, as described above, the MPEG2 encoder 3 can perform time-sharing control between re-encoding and recording, because the processing rate for decoding of the MPEG2 encoder 3 is twice as high as normal. To realize the time-sharing control between re-encoding and recording, the time-sharing control unit 25 controls the reading process by which the VOBU for dubbing is read from the HDD 4 and selects the input source for the MPEG2 encoder 3. FIG. 12 is a timing diagram which shows the status transitions of the record buffer 31, the re-encode buffer 32, and the track buffer 6 of FIG. 11. The following is the description of the control by the time-sharing control unit 25 with reference to the timing diagram in FIG. 12.

The first row in FIG. 12 represents the status transition of the record buffer 31. As described in FIG. 12, the graph which represents the status transition of the record buffer 31 includes a monotone increasing “rf1”, which means that broadcast content in the analog broadcast signal format received by the tuner is digitized by the MPEG2 encoder 3 and sequentially stored in the record buffer 31, and a monotone decreasing “rf2”, which means that each picture data stored in the record buffer 31 is sequentially outputted by the MPEG2 encoder 3. The slope of the monotone decreasing “rf2” is based on the output speed “Vout” from the record buffer 31 to the MPEG2 encoder 3, and the slope of the monotone increasing “rf1” is based on the difference between the input speed “Vin” from the A/D converter 2 to the record buffer 31 and the output speed “Vout” from the record buffer 31 to the MPEG2 encoder 3 (“Vin−Vout”). The picture data in the uncompressed digital format is inputted to the record buffer 31 at the display rate, because the broadcast content in the analog broadcast signal format is inputted at the display rate of the TV set, which means that the input speed “Vin” of the record buffer 31 is same as the display rate. Meanwhile, the processing rate of encoding by the MPEG2 encoder 3 is twice as high as the display rate, which means that “Vin−Vout” is same as “−Vout”. As a result, the slope of the monotone increasing is equal to the slope of the monotone decreasing in the status transition of the record buffer 31.

The third row in FIG. 12 represents the status transition of the re-encode buffer 32. The status transition of the re-encode buffer 32 in FIG. 12 is the same as the status transition of the encode buffer 11 in the third row in FIG. 5. The graph which represents the status transition of the re-encode buffer 32 includes a monotone increasing “ef1”, which means that a plurality of the picture data are sequentially stored in the re-encode buffer 32, and a monotone decreasing “ef2”, which means that the picture data stored in the re-encode buffer 32 is sequentially outputted to the MPEG2 encoder 3. The slope of the monotone decreasing “ef2” is based on the output speed “Vout” from the re-encode buffer 32 to the MPEG2 encoder 3, and the slope if the monotone increasing “ef2” is based on the difference between the input speed “Vin” from the MPEG2 decoder 7 to the re-encode buffer 32 and the output speed “Vout” from the re-encode buffer 32 to the MPEG2 encoder 3 (“Vin−Vout”).

Reading control for reading the VOBU for dubbing from the HDD 4 is triggered by that the accumulation in the record buffer 31 reaches a predetermined threshold value. The threshold value “sh3” in the first row in FIG. 12 represents a trigger for reading the VOBU for dubbing from the HDD 4. When the accumulation in the record buffer 31 reaches the threshold value “sh3”, the VOBU for dubbing is read from the HDD 4 to the track buffer 6 as indicated by an arrow “yd3” and a line “yk0”.

Control for choosing an input source is triggered by that the accumulation in the record buffer 31 reaches an upper limit “ug0”. The upper limit “ug0” in the first row in FIG. 12 represents a trigger by which the input source for the MPEG2 encoder 3 is switched to the record buffer 31. When the accumulation in the record buffer 31 reaches the upper limit “ug0”, the selector 33 is controlled to switch the input source for the MPEG2 encoder 3, which is to be encoded, to the record buffer 31, as indicated by an arrow “tg3”, and a line “yk1” in the forth row in FIG. 12. The accumulation in the record buffer 31 decreases through the control of the selector 33 (the monotone decreasing “rf2” in FIG. 12).

A lower limit “uw0” in FIG. 12 represents a trigger for switching the target source of encoding by the MPEG2 encoder 3 to the re-encode buffer 32. When the accumulation in the record buffer 31 reaches the lower limit “uw0”, the selector 33 is controlled to switch the input source for the MPEG2 encoder 3, which is to be encoded, to the re-encode buffer 32, as indicated by an arrow “tg4” and a line “yk2” in the fourth row in FIG. 12. The accumulation in the re-encode buffer 32 decreases through the control of the selector 33 (the monotone decreasing “ef2” in FIG. 12).

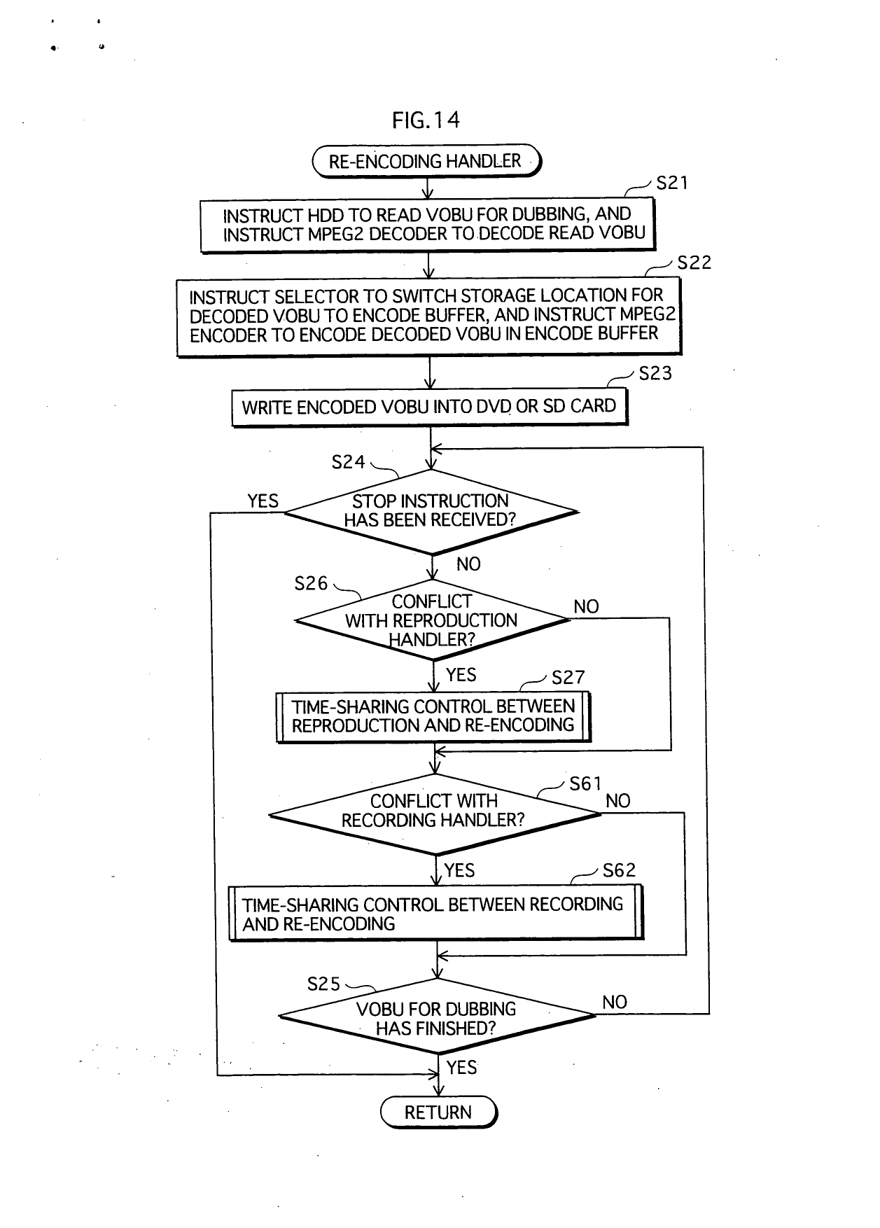

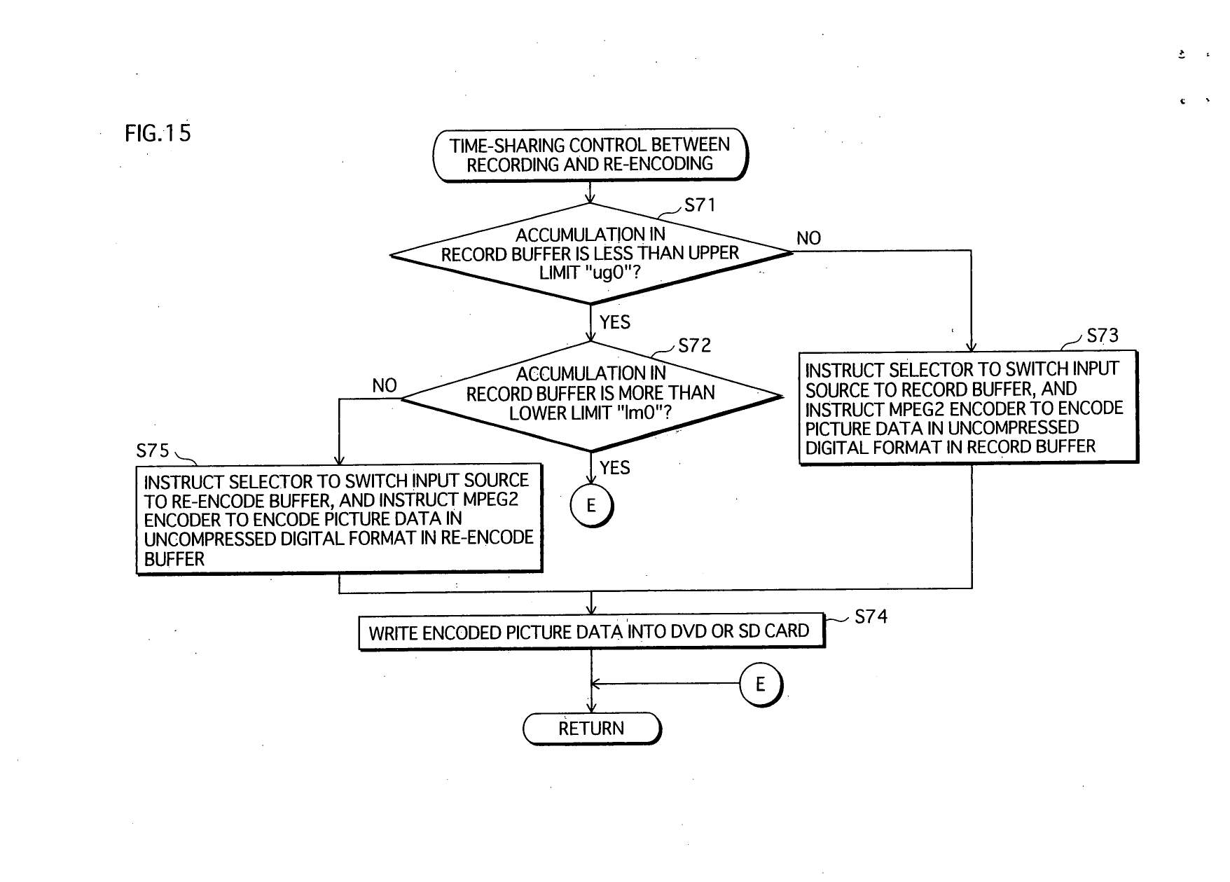

Adding to the above-described modification of the time-sharing control unit 25, the processing by the recording handler 21 and the processing by the re-encoding handler 23 are characteristic of the second embodiment. The following is the description of the processing procedure of the recording handler 21, the re-encoding handler 23, and the time-sharing control unit 25 of the second embodiment with reference to flowcharts in FIG. 14 and FIG. 15.

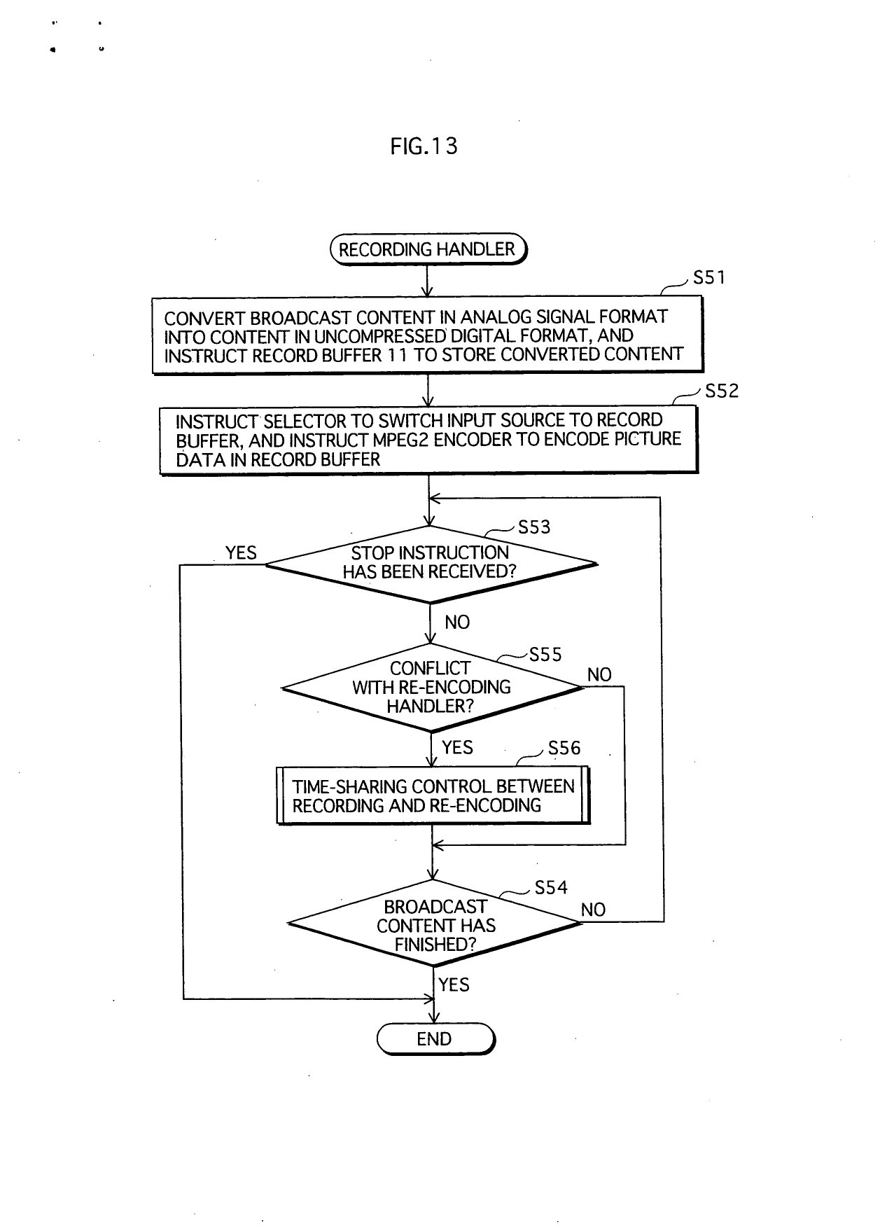

The recording handler 21 according to the second embodiment is substantially a subroutine program written in computer language for processing the procedure in FIG. 13. The following is the description of the processing procedure of the recording handler 21 with reference to the flowchart in FIG. 13. In the processing procedure represented by the flowchart, the recording handler 21 converts broadcast content in the analog signal format into broadcast content in the uncompressed digital format and instructs the record buffer 31 to store the converted content (step S51), instructs the selector 33 to switch the input source which is to be encoded to the record buffer 31, instructs the MPEG2 encoder 3 to encode picture data in the record buffer 31 (step S52), and then, repeats a procedure which consists of step S53 to S55 as a loop for waiting an event. This loop monitors events, which are whether a stop instruction has been received (step S53) and whether the input of the broadcast content which is to be recorded has finished (step S54), and when one of these events occurs, the subroutine program finishes and the processing returns to the main routine. While the recording handler 21 is working, the re-encoding handler 23 is also working. In the case where there is a conflict between the re-encoding handler 23 and the recording handler 21 (YES in step S55), the time-sharing control between the recording handler 21 and the re-encoding handler 23 is executed (step S56).

The re-encoding handler 23 according to the second embodiment is substantially a subroutine program written in computer language for processing the procedure in FIG. 14. In FIG. 14, step S61 is added to the loop processing in FIG. 9 which consists of step S24 to step S26. In step S61, it is judged whether there is a conflict between the recording handler 21 and the re-encoding handler 23. When there is a conflict, the time-sharing control between the recording and the re-encoding is executed (step S62).

The time-sharing control unit 25 according to the second embodiment is substantially a subroutine program written in computer language for processing the procedure in FIG. 15. The following is the description of the processing procedure of the time-sharing control unit 25 with reference to the flowchart in FIG. 15. In the processing procedure represented by the flowchart, the processing returns without executing any processing to the main routine which called this subroutine program when the accumulation in the record buffer 31 is less than the upper limit “ug0” (step S71) and is more than the lower limit lm0 (step S72).

When the accumulation in the record buffer 31 is not less than the upper limit “ug0” (“No” in step S71), the time-sharing control unit 25 instructs the selector 33 to switch the input source to the record buffer 31, instructs the MPEG2 encoder 3 to encode picture data in the uncompressed digital format stored in the record buffer 31 (step S73), and writes the encoded picture data into the DVD 102 or the SD card 103 (step S74).

When the accumulation in the record buffer 31 is not more than the lower limit lmO (“No” in step S72), the time-sharing control unit 25 instructs the selector 33 to switch the input source to the re-encode buffer 32, instructs the MPEG2 encoder 3 to encode picture data in the uncompressed digital format stored in the re-encode buffer 32 (step S75), and writes the encoded picture data into the DVD 102 or the SD card 103 (step S74).

According to the amount of the accumulation in the record buffer 31, the target of encoding is switched between the record buffer 31 and the re-encode buffer 32.

The above-described embodiment allows a user to record broadcast content which the user wants to watch during re-encoding of broadcast content which the user wants to bring out and watch outside. As a result, the user does not need to abandon neither the recording nor the re-encoding.

Note that the time-sharing control in the second embodiment is to avoid a conflict for the use of the MPEG2 encoder 3, and may coexist with the time-sharing control in the first embodiment. Accordingly, the user may reproduce content during the recording of other content, and may also reproduce other content which is recorded in the HDD 4.

<The Third Embodiment>

In the first embodiment, the user can watch broadcast content during re-encoding of other content, however, the user has no way of knowing the progress of the re-encoding. The third embodiment relates to the improvement by which the user is allowed to know the progress of the re-encoding during the reproduction of other content.

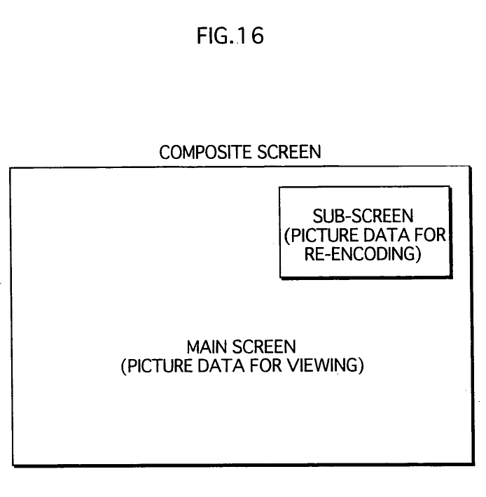

This improvement is achieved by generating a composite screen in the view buffer 8 as shown in FIG. 16. In the composite screen in FIG. 16, picture data for viewing is displayed as a main screen and picture data for re-encoding is displayed as a sub-screen. The main screen and the sub-screen are steadily updated, using picture data which is obtained by the decoding as the reproduction and the re-encoding proceed. This allows the user to know the progress of the re-encoding during the reproduction of broadcast content.

<Notes>

The above-described embodiments are examples of the system for offering maximum result, and various changes may be made without departing from the scope of the invention. The followings are representative modifications of the embodiments.

(A) Although the HD recorder 100 in the first, second and third embodiment is a HD recorder which is connected to the TV set 101, the HD recorder may be a combination HD recorder with a liquid crystal display. Also, the HD recorder 100 in the first embodiment has a built-in HD drive and a built-in MPEG2 encoder, however, a HD drive and a MPEG2 encoder may be connected to the HD recorder via an IEEE1394 connector. Also, the HD recorder 100 may include only the microcomputer system which executes substantial part of the processing.

Each above-described HD recorder 100 is in the description of the present invention, and producing the HD recorder 100 according to the internal configuration described in the first, second, and third embodiment means implementation of the present invention in the description. Transference with/without consideration (transference with consideration is a sale and transference without consideration is a donation), lending and import of the HD recorder 100 described in the first, second, and third embodiment are also the implementation of the present invention. Possessing manufactures or semi-manufactures of the HD recorder 100 and offering transference of those manufactures or lending those manufactures to general users by storefront display, catalogs, or brochure distribution are also implementations of the present invention.

(B) The information processing by programs, which is represented in FIG. 7 to FIG. 10 and FIG. 13 to FIG. 15, is embodied with use of hardware resources such as a CPU, a MPEG encoder, and a HD drive, therefore the programs are an invention in themselves. In the first, second, and third embodiment, implementations of the programs installed in the HD recorder 100 are described, however, the programs represented in the first, second, and third embodiment may be separated from the HD recorder 100 and implemented. The implementation of the programs includes: (1) Production of the programs (2) Transference of the programs with/without consideration (3) Lending (4) Import (5) Offering the programs to the public via an interactive electronic communication line (6) Offering transference of the programs or lending of the programs to general users by storefront display, catalogs, or brochure distribution.

The implementation (6) includes transferring the programs to a user for use (program download service) and offering the functions of the programs to a user via an interactive electronic communication line without transferring the program (ASP service for offering functions of programs).

(C) The steps in the flowcharts in FIG. 7 to FIG. 9 are sequentially executed, therefore, the passage of time, which is an element of the flowchart, is essential for specifying the invention. On the basis of this perspective, it is clear that the processing procedures represented by the flowcharts disclose an embodiment for recording. The flowcharts are the embodiments of the present invention. Executing the processing procedure of the steps sequentially to achieve the object of the present invention and to gain the operation and the effect of the present invention means implementation of the recording method according to the present invention.

(D) In the first, second, and third embodiments, a Hard Disk is used as an internal storage medium in the HD recorder 100. However, the physical features of the Hard Disk are not conducive to the operation and the effect of the present invention. Adding to a Hard Disk, any storage medium which has a storage capacity for recording broadcast content may be used. For instance, an Optical Disc such as a DVD−R, a DVD−RW, a DVD-RAM, a DVD+R, a DVD+RW, a CD-R, a CD-RW, and a Blu-ray Disc may be used as the storage medium. Also, a magnetic optical disc such as a PD and a MO may be used.

In the first, second, and third embodiments, a SD memory card is used as a portable storage medium. However, a semiconductor memory card, such as a Compact Flash, a SmartMedia, a Memory Stick, a MultiMediaCard, and a PCMCIA card may be used. Also, a magnetic storage disk such as a FlexibleDisk, a SuperDisk, a Zip, and a Clik!, and a removal hard disk drive such as an ORB, a Jaz, a SparQ, a SyJet, an EZfley, and a MicroDrive may be used as a portable medium.

(E) Content in the first, second, and third embodiments is a VOB which is obtained by encoding analog video signals of analog broadcasting, however, the content may be stream data of digital broadcasting which includes transport streams.

Also, the content may be obtained by encoding analog/digital video signals which are recoded on a videotape or directly loaded from a video camera. Also, the content may be a digital copyrighted work, such as a movie, which is previously recorded in a storage medium and distributed or distributed via a distribution server.

(F) In the first, second, and third embodiments, the remote control receives an instruction from a user for selecting a content which is to be recorded, however, the front panel of the recording apparatus may accept the instruction. Also, an input device such as a Keyboard, a touch-sensitive panel, a mouse, a pad, or a track ball may accept the instruction. In this case, the instruction may be given by a click and a drag.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A recording apparatus which executes, in parallel, processes of (1) re-encoding first video data recorded in a first storage medium, and writing the re-encoded first video data into a second storage medium, and (2) reproducing second video data, comprising:
a reading unit operable to read the first video data and the second video data from the first storage medium;
a view buffer;
an encode buffer;
a decoder operable to decode the first video data and the second video data by time-sharing, write the decoded first video data into the encode buffer, and write the decoded second video data into the view buffer;
an output unit operable to output the decoded second video data stored in the view buffer at a display rate; and
an encoder operable to encode the decoded first video data stored in the encode buffer, wherein
the decoder performs the decoding and the writing at a higher processing rate than the display rate.

2. The recording apparatus of claim 1, wherein
the decoding at the higher processing rate is realized by performing the decoding at a higher operating frequency than an operating frequency based on the display rate, and
the view buffer is a dual port memory for absorbing a difference between the operating frequency based on the display rate and the higher operating frequency.

3. The recording apparatus of claim 2 further comprising:
a control unit operable to monitor an amount of the second video data accumulated in the view buffer and an amount of the first video data accumulated in the encode buffer, wherein
the reading of the first video data is perf formed when the amount of the accumulation in the view buffer reaches a first threshold value, and
the reading of the second video data is performed when the amount of the accumulation in the encode buffer reaches a second threshold value.

4. The recording apparatus of claim 3, wherein
the writing of the decoded first video data into the encode buffer is performed when the amount of the accumulation in the view buffer reaches an upper limit of the view buffer, and
the writing of the decoded second video data into the view buffer is performed when the amount of the accumulation in the encode buffer reaches an upper limit of the encode buffer.

5. The recording apparatus of claim 1, wherein
the output is of a composite picture consisting of the second video data as a main picture and the first video data as a sub-picture, the composite picture being generated by compositing the decoded first video data with the decoded second video data.

6. The recording apparatus of claim 1, wherein
the encode buffer includes a re-encode buffer and a record buffer,
the decoder decodes the first video data and writes the decoded first video data into the re-encode buffer,
the recording apparatus further comprises a reception unit operable to receive a broadcast wave in order to obtain uncompressed digital data, and write the obtained data into the record buffer, and
the encoder re-encodes the decoded data in the re-encode buffer and encodes the uncompressed digital data in the record buffer by time-sharing at the higher processing rate than the display rate.

7. The recording apparatus of claim 6, further comprising:
a control unit operable to monitor an amount of an accumulation in the record buffer, wherein
the reading of the first video data from the first storage medium is performed when the amount of the accumulation in the record buffer reaches a third threshold value.

8. The recording apparatus of claim 7, wherein
the control unit (1) provides the encoder with the uncompressed digital data stored in the record buffer when the amount of the accumulation in the record buffer reaches an upper limit of the record buffer, and (2) provides the encoder with the decoded data stored in the re-encode buffer when the amount of the accumulation in the record buffer reaches a lower limit of the record buffer.

9. An integrated circuit which executes, in parallel, processes of (1) re-encoding first video data recorded in a first storage medium, and writing the re-encoded first video data into a second storage medium, and (2) reproducing second video data, comprising:
a reading unit operable to read the first video data and the second video data from the first storage medium;
a view buffer;
an encode buffer;
a decoder operable to decode the first video data and the second video data by time-sharing, write the decoded first video data into the encode buffer, and write the decoded second video data into the view buffer;
an output unit operable to output the decoded second video data stored in the view buffer at a display rate; and
an encoder operable to encode the decoded first video data stored in the encode buffer, wherein
the decoder performs the decoding and the writing at a higher processing rate than the display rate.

10. A computer-readable program which executes, in parallel, processes of (1) re-encoding first video data within a computer including view buffer, an encode buffer, and an encoder, and writing the re-encoded first video data into a second storage medium and (2) reproducing a second video data, comprising:
a first step for reading the first video data and the second video data from the first storage medium;
a second step for controlling the decoder to decode the first video data and the second video data by time-sharing, to write the decoded first video data into the encode buffer, and to write the decoded second video data into the view buffer;
a third step for controlling the encoder to encode the decoded first video data stored in the encode buffer; and
a fourth step for reproducing the decoded second video data at a display rate, wherein
the decoder performs the decoding and the writing at a higher processing rate than the display rate.

11. The recording apparatus of claim 2, wherein
the output is of a composite picture consisting of the second video data as a main picture and the first video data as a sub-picture, the composite picture being generated by compositing the decoded first video data with the decoded second video data.

12. The recording apparatus of claim 3, wherein
the output is of a composite picture consisting of the second video data as a main picture and the first video data as a sub-picture, the composite picture being generated by compositing the decoded first video data with the decoded second video data.

13. The recording apparatus of claim 4, wherein
the output is of a composite picture consisting of the second video data as a main picture and the first video data as a sub-picture, the composite picture being generated by compositing the decoded first video data with the decoded second video data.
